(19) United States
(12) Patent Application Publication
(10) Pub. No.: US 2022/0379575 A1
(43) Pub. Date: Dec. 1, 2022

(54) TENSION-ACTIVATED, EXPANDING ARTICLES WITH MULTIBEAM SLITS

(71) Applicant: 3M INNOVATIVE PROPERTIES COMPANY, St. Paul, MN (US)

(72) Inventors: Thomas R. Corrigan, St. Paul, MN (US); Patrick R. Fleming, Lake Elmo, MN (US); Anne C.F. Gold, South St. Paul, MN (US); Silvia G. Guttmann, St. Paul, MN (US); Nicholas K. Lee, Minneapolis, MN (US); Delony L. Langer-Anderson, Hugo, MN (US); Lisa M. Miller, Spring Valley, WI (US); Manoj Nirmal, St. Paul, MN (US)

(21) Appl. No.: 17/787,370

(22) PCT Filed: Dec. 21, 2020
(86) PCT No.: PCT/IB2020/062294

§ 371 Date: Jun. 20, 2022

Related U.S. Application Data
(60) Provisional application No. 62/952,840, filed on Dec. 23, 2019.
(60) Provisional application No. 63/058,099, filed on Jul. 29, 2020.

(51) Int. Cl. B31D 1/00; B31D 3/02; B31D 5/00

(52) U.S. Cl. CPC B31D 1/0031; B31D 3/0207; B31D 5/0065

(57) ABSTRACT

The present disclosure relates generally to tension-activated, expanding articles that include a plurality of patterned slits. At least some of the plurality of slits are multibeam slits that, when the material into which the slits are formed is tension-activated form one or more multibeams. In some embodiments, these articles are used as cushioning films and/or packaging materials. The present disclosure also relates to methods of making and using these tension-activated, expanding articles.

### TECHNICAL FIELD

The present disclosure relates generally to tension-activated, expanding articles that include a plurality of patterned slits. At least some of the plurality of slits are multibeam slits that, when the material into which the slits are formed is tension-activated form one or more multibeams. In some embodiments, these articles are used as cushioning films and/or packaging materials. The present disclosure also relates to methods of making and using these tension-activated, expanding articles.

### BACKGROUND

In 2016, consumers bought more products online than in stores. (Consumers Are Now Doing Most of their Shopping Online, Fortune Magazine, Jun. 8, 2016). Specifically, consumers made 51% of their purchases online and 49% in brick-and-mortar stores. Id. One result of this change in consumer behavior is the growing number of packages mailed and delivered each day. Over 13.4 billion packages are delivered to homes and businesses around the world each year (about 5.2 billion by the United States Postal Service, about 3.3 billion by Fed Ex, and about 4.9 billion by UPS). While delivery of non-package mail is decreasing annually, package delivery is growing at a rate of about 8% annually. This growth has resulted in 25% of the U.S. Postal Service's business being package delivery. (Washington Examiner, “For every Amazon package it delivers, the Postal Service loses $1.46,” Sep. 1, 2017). Amazon ships about 3 million packages a day, and Alibaba ships about 12 million packages a day.

It is not just businesses shipping packages. The growing Maker culture creates opportunities for individuals to ship their handmade products around the world through websites like Etsy™. Further, the increased focus on sustainability causes many consumers to resell used products on sites like eBay™ rather than throwing them into landfills. For example, over 25 million people sell goods on eBay™, and over 171 million people buy these goods.

Individuals and businesses shipping these goods often ship them in shipping containers, typically boxes, including the product to be shipped, cushioning, and air. Boxes have many advantages, including, for example, the box can stand upright, it is lightweight, stored flat, is recyclable, and is relatively low cost. However, boxes come in standard sizes that often do not match the size of the item being shipped, so the user must fill the box with a large amount of filler or cushioning material to try to protect the item being shipped from jostling around in a box that is too large and becoming damaged.

Package cushioning materials protect items during shipment. The effects of vibration and impact shock during shipment and loading/unloading are mitigated by the cushioning materials to reduce the chance of product damage. Cushioning materials are often placed inside the shipping container where they absorb energy by, for example, buckling and deforming, and/or by dampening vibration or transmitting the shock and vibration to the cushioning material rather than to the item being shipped. In other instances, packaging materials are also used for functions other than cushioning, such as to immobilize the item to be shipped in the box and fix it in place.

Alternatively, packaging materials are also used to fill a void such as, for example, when a box that is significantly larger than the item to be shipped is used.

Some exemplary packaging materials include plastic Bubble Wrap™, bubble film, cushion wrap, air pillows, shredded paper, crinkle paper, shredded aspen, vermiculite, cradles, and corrugated bubble film. Many of these packaging materials are not recyclable.

One exemplary packaging material is shown in FIGS. 1A and 1B. Film 100 is made of a paper sheet including pattern of a plurality of cuts or slits 110 that is often referred to as a “skip slit pattern,” a type of single slit pattern. When film 100 is tension-activated (pulled along the tension axis (T), which is substantially perpendicular to cuts or slits 110), a plurality of beams 130 are formed. Beams 130 are regions between adjacent coaxial rows of slits. The beams 130 formed by slits 110 collectively experience some degree of upward and downward movement (see, for example, FIGS. 1B and 1D). This upward and downward movement results in the two-dimensional article (a substantially flat sheet) of FIG. 1A becoming the three-dimensional article of FIGS. 1B and 1D when tension-activated. When this film is used as packaging material, the three-dimensional structure provides some degree of cushioning as compared to a two-dimensional, flat structure.

The cut or slit pattern of film 100 is shown in FIG. 1C and is described in U.S. Pat. No. 4,105,724 (Talbot) and U.S. Pat. No. 5,667,871 (Goodrich et al.). The pattern includes a plurality of substantially parallel rows 112 of multiple individual linear slits 110. Each of the individual linear slits 110 in a given row 112 is out of phase with each of the individual linear slits 110 in the directly adjacent and substantially parallel row 112. In the specific construction of FIGS. 1A-1C, the adjacent rows 112 are out of phase by one half of the horizonal spacing. The pattern forms an array of slits 110 and rows 112, and the array has a regular, repeating pattern across the array. Between directly adjacent rows 112 of slits 110 are formed beams 130 of material.

FIG. 2A shows the cut or slit pattern of film 100 of FIGS. 1A-1C rotated 90°. Each linear slit 110 has a length (L) that extends between a first terminal end 114 and a second terminal end 116. Each linear slit 110 also has a midpoint 118 that is halfway between the first and second terminal ends 114,116. Midpoint 118 is shown by a dot on slit 110A of FIG. 2A. The midpoints 118 of parallel and aligned slits 110 substantially align with one another. In other words, the midpoint 118 of an individual linear slit 110 substantially aligns with the midpoint 118 of an individual linear slit 110 on a directly adjacent beam 130 along the tension axis (T). Such slits 110 are not in directly adjacent slit rows 112; instead, they are on alternating rows 112. Further, the midpoint 118 of an individual slit 110 is between the terminal ends 114, 116 of the directly adjacent slits or cuts 110 along the tension axis (T). The distance between the center of two directly adjacent slits 110 in a row 112 of slits 110 is identified as the transverse spacing (H). The thickness of beam 130 or distance between two adjacent rows 112 of adjacent linear slits 110 is identified as the axial spacing (V).

More specifically, in the embodiment of FIG. 2A, midpoint 118A of slit 110A aligns axially with midpoint 118B of slit 110B. Slit 110B is on the beam 130B directly adjacent to beam 130A on which slit 110A lies. Also, midpoint 118A of slit 110A is between terminal end 114C of slit 110C and terminal end 116D of slit 110D. Slits 110C and 110D are directly adjacent to slit 110A axially. FIG. 2A also shows the transverse pitch (H) between transversely adjacent midpoints 118, the axial pitch (V) or beam 130 height, the slit length (L), and the tension axis (T) along which tension can be provided to cause upward and downward movement of beams 130.

FIG. 2B shows the primary tension lines (e.g., the lines approximating the highest tensile stress path) formed when an article including the slit pattern of FIG. 2A is deployed with tension. FIG. 2B shows in red dotted lines the primary tension lines 140, which are where the greatest tensile stress will occur. Tension lines are imaginary paths through the material that carry the greatest load when tension is applied to the material along the tension axis. When tension is applied along tension axis (T), the primary tension lines 140 move more closely into alignment with the applied tension axis, causing the material or sheet into which the pattern has been formed to distort. When single slit patterns are deployed, the activation of tension along the primary tension lines 140 causes substantially all regions of the pattern to experience some tension or compression (tensile stress or compressing stress) and then buckle and bend out of the plane of the original two-dimensional film. In some embodiments, when the film is fully deployed and/or tension is applied to the desired extent, substantially no regions exist in the film that remain parallel to the original plane of the sheet.

### SUMMARY

The inventors of the present disclosure invented novel slit patterns that include at least some multibeam slits that, when the material into which the slits are formed is tension-activated form one or more multibeams. In some embodiments, materials or articles that include multibeam slit patterns have a greater maximum tension force as compared to a material or article with the same pattern of beams except that they lack multibeams. As used herein, the term “maximum tension force” refers to the maximum tensile force that can be applied to a sample of slit-patterned material before it tears. Generally, the maximum tension force occurs just before a slit-patterned material tears. A test method for measuring the maximum tension force is described below. In some embodiments, materials or articles that include a multibeam slit pattern are capable of withstanding larger tension forces without tearing as compared to a material or article with the same pattern except without multibeams.

In some embodiments, materials or articles with multibeam slit patterns have the same or lower deployment force. As used herein, the term “deployment force” refers to the force required to substantially deploy the patterned sheet, it is defined in the test method below.

In some embodiments, it is advantageous to have the maximum tension force (the tension force required to tear the slit patterned material during deployment or tensioning along tension axis T) be greater than the deploy force (the force required to deploy the sample). The Max-Deploy Ratio is the ratio of the maximum tension force divided by the deploy force. In some embodiments, it is advantageous for that ratio to be as large as possible such that the force applied to deploy a patterned sheet is much lower than the maximum force that the sheet can sustain. This prevents users of the sheet from accidentally tearing the material when deploying it.

These slit patterns can be used to form tension-activated, expanding articles. In some embodiments, the articles can be used for shipping and packaging applications. However, the articles and patterns can also be used for a plethora of other uses or applications. So, the present disclosure is not meant to be limited to shipping or packaging material applications, which are merely one exemplary use or application.

### BRIEF DESCRIPTION OF DRAWINGS

The disclosure may be more completely understood in consideration of the following detailed description of various embodiments of the disclosure in connection with the accompanying drawings.

FIG. 1A is top view line drawing of an exemplary prior art slit pattern used to form the packaging material of FIGS. 1B and 1C.

FIG. 1B is a drawing of the pattern shown in FIG. 1A formed in a paper sheet and exposed to tension along the tension axis.

FIG. 1C is a magnified view of a portion of the photograph of FIG. 1B.

FIG. 2A is a top view line drawing of the slit pattern used to form the packaging material of FIGS. 1A and 1B rotated 90 degrees.

FIG. 2B shows the primary tension lines of the slit pattern shown in FIG. 2A.

FIG. 3A is a top view schematic drawing of an exemplary single slit pattern.

FIG. 3B is a perspective view drawing created from a photograph of the pattern shown in FIG. 3A formed in a paper sheet and exposed to tension along the tension axis.

FIG. 3C is a nearly top view drawing from a photograph of the article of FIG. 3B when exposed to tension along the tension axis.

FIG. 3D is an elevated side view of the article shown in FIG. 3B.

FIG. 4A is a top view schematic drawing of an exemplary single slit pattern.

FIG. 4B is a perspective view drawing from a photograph of the pattern shown in FIG. 4A formed in a paper sheet and exposed to tension along the tension axis.

FIG. 5A is a top view schematic drawing of an exemplary double slit pattern.

FIG. 5B is a nearly top view drawing from a photograph of the double slit pattern of FIG. 5A formed in a paper sheet and exposed to tension along the tension axis.

FIG. 5C is a nearly side view drawing created from a photograph of the double slit pattern of FIG. 5A formed in a paper sheet and exposed to tension along the tension axis.

FIG. 6A is a top view schematic drawing of an exemplary double slit pattern.

FIG. 6B is an enlarged portion of FIG. 6A.

FIG. 6C is a perspective view drawing from a photograph of the pattern shown in FIG. 6A formed in a paper sheet and exposed to tension along the tension axis.

FIG. 6D is a nearly top view photograph of the double slit pattern of FIG. 6A formed in a paper sheet and exposed to tension along the tension axis.

FIG. 6E is a nearly side of view photograph of the double slit pattern of FIG. 6A formed in a paper sheet and exposed to tension along the tension axis.

FIG. 7A is a top view schematic drawing of an exemplary double slit pattern.

FIG. 7B is a nearly side view drawing from a photograph of a material into which the slit pattern of FIG. 7A has been formed after it has been deployed by application of tension along the tension axis.

FIG. 8A is a top view schematic drawing of an exemplary compound slit pattern.

FIG. 8B shows the primary tension lines in the compound slit pattern of FIG. 8A when it is exposed to tension.

FIGS. 8C-8E are top view schematic drawings showing the movement of the material into which the slit pattern of FIG. 8A has been formed when the material is exposed to tension.

FIG. 8F is a perspective side view schematic drawing of a portion of the material into which the slit pattern of FIG. 8A has been formed when the material is exposed to tension.

FIG. 8G is a perspective side view schematic drawing of the material into which the slit pattern of FIG. 8A has been formed when the material is exposed to tension.

FIGS. 8H-8J are images of the compound slit pattern of FIG. 8A formed in a paper sheet and exposed to tension along the tension axis. FIG. 8H is a nearly side view, FIG. 8I is a nearly top view, and FIG. 8J is a top view.

FIG. 9 is a top view schematic drawing of an exemplary compound slit pattern.

FIG. 10 is a top view schematic drawing of an exemplary compound slit pattern.

FIG. 11A is a top view schematic drawing of an exemplary compound slit pattern.

FIGS. 11B-11E are drawings from photographs showing the pattern of FIG. 11A cut into a material and deployed along the tension axis shown from the perspective, nearly side, perspective, nearly top, and top views, respectively.

FIGS. 12-21 are top down view schematic drawings of exemplary slit patterns.

FIGS. 22A and 22B are top and three-quarter, respectively, view schematic drawings of an exemplary compound slit pattern.

FIGS. 22C-22E are a three-quarter, front, side, and top-down views, respectively, a portion of a sheet into which the slit pattern of FIG. 8A has been formed when the material is exposed to tension.

FIG. 23 is an example system for making materials consistent with the technology disclosed herein.

### DETAILED DESCRIPTION

In the following detailed description, reference may be made to the accompanying set of drawings that form a part hereof and in which are shown by way of illustration several specific embodiments. It is to be understood that other embodiments are contemplated and may be made without departing from the scope or spirit of the present disclosure.

Various embodiments of the present disclosure relate to slit patterns and to articles including slit patterns. A “slit” is defined herein as a narrow cut through the article forming at least one line, which may be straight or curved, having at least two terminal ends. Slits described herein are discrete, meaning that individuals slits do not intersect other slits. A slit is generally not a cut-out, where a “cut-out” is defined as a surface area of the sheet that is removed from the sheet when a slit intersects itself. However, in practice, many forming techniques result in the removal of some surface area of the sheet that is not considered a “cut-out” for the purposes of the present application. In particular, many cutting technologies produce a “kerf”, or a cut having some physical width. For example, a laser cutter will ablate some surface area of the sheet to create the slit, a router will cut away some surface area of the material to create the slit, and even crush cutting creates some deformation on the edges of the material that forms a physical gap across the surface area of the material. Furthermore, molding techniques require material between opposing faces of the slit, creating a gap or kerf at the slit. In various embodiments, the gap or kerf of the slit will be less than or equal to the thickness of the material. For example, a slit pattern cut into paper that is 0.007″ thick might have slits with a gap that is approximately 0.007″ or less. However, it is understood that the width of the slit could be increased to a factor that is many times larger than the thickness of the material and be consistent with the technology disclosed herein.

Slits can be characterized as “simple slits” or “compound slits,” where a “simple slit” is defined as having exactly two terminal ends and a “compound slit” has more than two terminal ends. As used herein, the term “single slit pattern” refers to a pattern of individual slits that form individual rows each extending across the sheet transversely, where the rows form a repeating pattern of individual rows along the axial length of the sheet, and the pattern of slits in each row is different than the pattern of slits in the directly adjacent rows. For example, the slits in one row may be axially offset or out of phase with the slits in the directly adjacent rows.

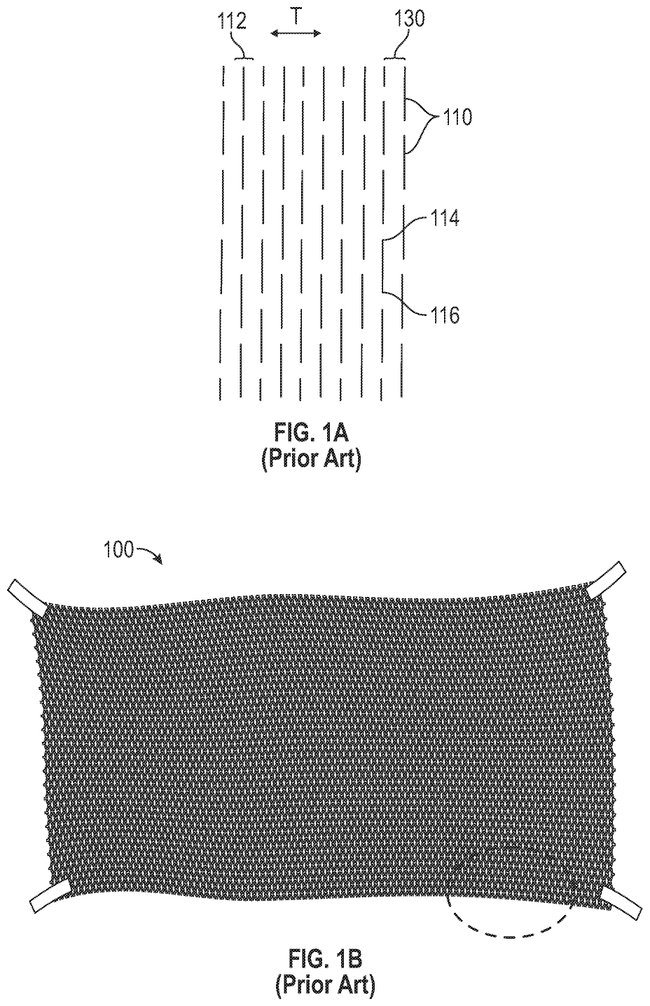

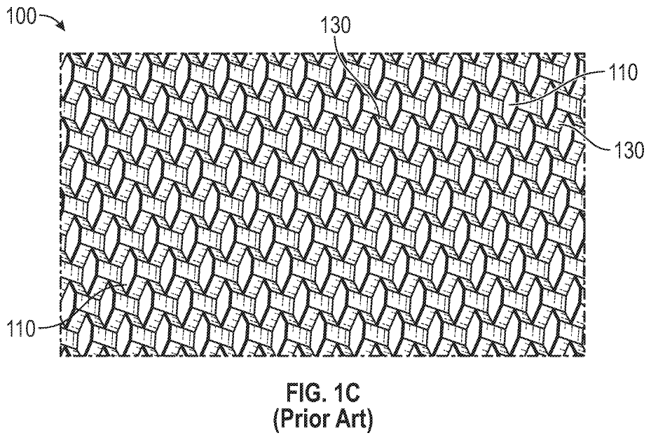

In some embodiments, the slit or flap shapes described herein amplify the out-of-plane motion of the materials or articles as compared to the prior art slit shapes of FIGS. 1A and 1B. The enhanced dimensionality of the slit/flap shapes described herein, as compared to the prior art slit/flap shapes of FIGS. 1A and 1B, creates interlocking features. Whether a material is interlocking can be determined by the following test method.

A sample measuring 36-inches (0.91 m) long and 7.5-inches (19 cm) wide was obtained. The sample was fully deployed without tearing, and was then placed directly adjacent to a smooth PVC pipe (for example, a one having an outer diameter (OD) of 3.15 inches (8 cm) and a length of 23 inches (58.4 cm)), ensuring that the sample remained fully deployed during rolling. The sample was wrapped over the pipe ensuring that each successive layer was placed directly over the previous layer and that the sample was placed at the center (along the length) of the pipe. The same will provide a minimum of two complete wraps around the pipe. When all the sample was wrapped around the pipe, the sample was released and whether the sample unfolded/unwrapped was observed. If the sample did not unfold/unwrap after a 1-minute wait, the sample was slid off the pipe onto a smooth surface such as a tabletop. The sample was then lifted by the trailing edge to see if it unrolled/unwrapped or held its shape.

If the sample opened/unwrapped within a minute of being released, during sliding it off the pipe, or when lifted by the trailing edge, the sample was deemed “not interlocking”. If the sample held its tubular shape during and after sliding it off the pipe and when lifted by the trailing edge, then it was deemed interlocking. The test was repeated 10 times for each sample.

In some embodiments, the slit pattern includes one or more multibeam slits that, when the material into which the slits are formed is tension-activated form one or more multibeams. Materials or articles that include multibeam slit patterns have a greater maximum tension force as compared to a material or article having the same pattern of beams except that it lacks multibeams. As used herein, the term “maximum tension force” refers to the maximum tensile force that can be applied to a sample of slit-patterned material before it tears. Generally, the maximum tension force occurs just before a slit-patterned material tears. A test method for measuring the maximum tension force is described below. In some embodiments, materials or articles that include a multibeam slit pattern are capable of withstanding larger tension forces without tearing as compared to a material or article with the same pattern except without multibeams.

In some embodiments, materials or articles with multibeam slit patterns have the same or lower deployment force. As used herein, the term “deployment force” refers to the force required to substantially deploy the patterned sheet.

In some embodiments, it is advantageous to have the maximum tension force (the tension force required to tear the slit patterned material during deployment or tensioning along tension axis T) be greater than the deploy force (the force required to deploy the sample). The Max-Deploy Ratio is the ratio of the maximum tension force divided by the deploy force. In some embodiments, it is advantageous for that ratio to be as large as possible such that the force applied to deploy a patterned sheet is much lower than the maximum force that the sheet can sustain. This prevents users of the sheet from accidentally tearing the material when deploying it.

### Single Slit Patterns

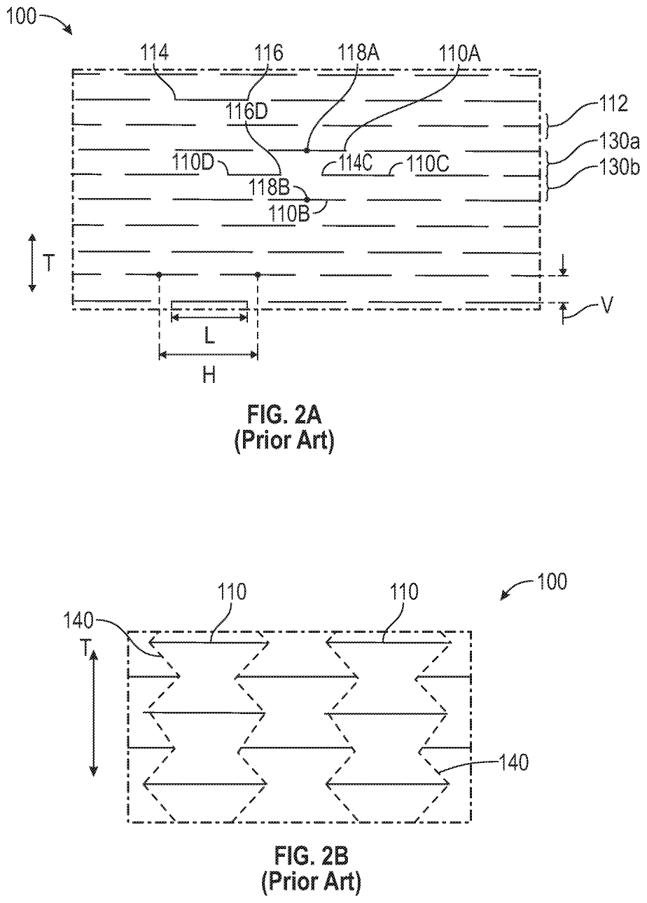

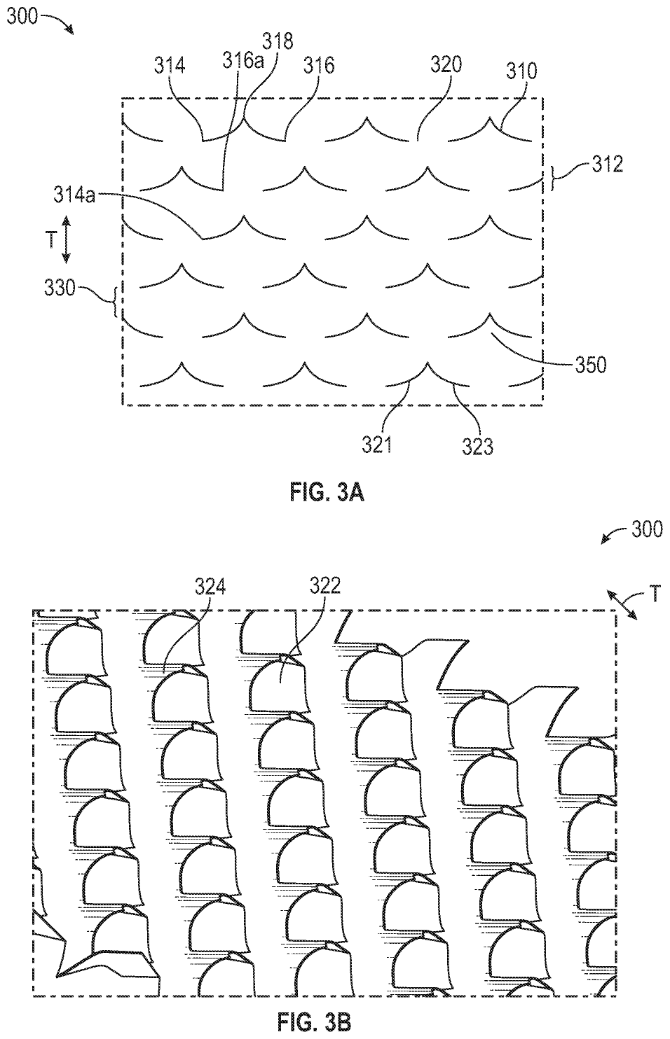

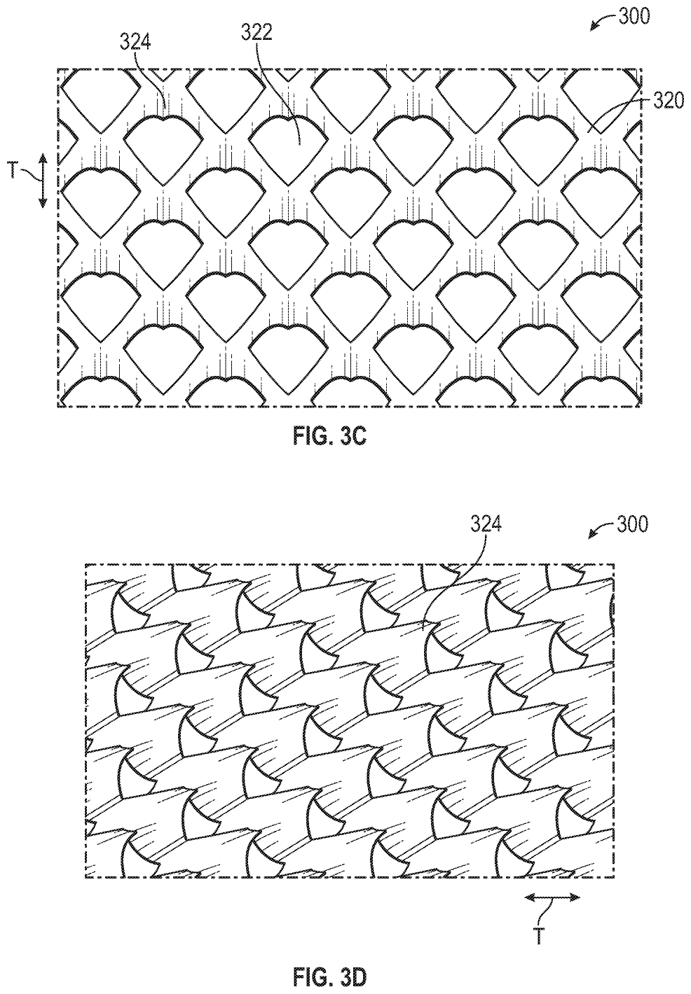

An exemplary embodiment of a single slit pattern is shown schematically in FIG. 3A. The single-slit pattern is formed in material 300 and includes a plurality of slits 310 that each include a first terminal end 314, a second terminal end 316, and a midpoint 318. A plurality of individual slits 310 are aligned to form rows 312 that are generally perpendicular to tension axis T. “Generally perpendicular” is defined herein as encompassing angles within a 5-degree margin of error or within a 3-degree margin of error. Transverse spacing between the slits results in material forming an axial beam 320 between adjacent slits 310 in a row 312. The material between directly adjacent rows 312 of slits 310 forms transverse beams 330. In the exemplary embodiment of FIG. 3A, slits 310 are not straight lines (like slits 110 of the slit pattern of FIGS. 1A and 2A). Instead, slits 310 are generally v-shaped or cusp-shaped. Slits 310 comprise a curved first portion 321 that is generally at a 45 degree angle to tension axis T and that connects with curved second portion 323 at a generally oblique angle. First and second portions 321, 323 connect at midpoint 318. The flap region 350 is generally the area enclosed by the path of slit 310 and the imaginary straight line between terminal ends 314 and 316.

In this exemplary embodiment, the slits are “simple slits,” which are defined herein as slits having two terminal ends. A straight, imaginary line extends between and connects these terminal ends. In this embodiment, the straight, imaginary line extending between and connecting the terminal ends of a first slit is substantially colinear with the straight, imaginary line extending between and connecting the terminal ends of a directly adjacent slit. In this exemplary embodiment, all of the straight, imaginary lines extending between and connecting the slit terminal ends in a row are approximately colinear.

Those of skill in the art will appreciate that many changes may be made to the pattern while still falling within the scope of the present disclosure. For example, the first and second portions 321, 323 can vary in length, curvature, shape, or angle relative to tension axis T. The first and second portions 321, 323 can intersect at angle other than oblique (e.g., acute or perpendicular). Alternatively, the slit length, row size or shape, and beam size or shape can vary. Those of skill in the art will also appreciate that the intersection between first and second portions 321, 323 can be rounded. Further, the degrees of offset or phase offset can vary from what is shown.

FIGS. 3B-3D show the pattern of FIG. 3A formed in a sheet of paper and exposed to tension along the tension axis T. When material 300 is tension activated or deployed along tension axis T, portions of material 300 experiences tension and/or compression that causes the material to move out of the original plane of material 300 in its pretensioned format. When exposed to tension along the tension axis, terminal ends 314, 316 experience compression and are drawn toward one another, causing flap region 350 of the material 300 to move or buckle upward relative to the plane of the material 300 in its pretensioned state (FIG. 3A), creating flap 324. Portions of beams 330 move or buckle downward relative to the plane of the material 300 in its pretensioned state (FIG. 3A), forming an opening portion 322. The axial beam 320 between adjacent slits 310 in a row 312 primarily experiences tension perpendicular to tension axis T. This region or area does not move substantially out of the original plane and instead bends slightly as compared to the pretensioned form of FIG. 3A. These movements in material 300 form a series of cusp-pointed protrusions, as seen in FIG. 3D.

When the tension-activated material 300 is wrapped around an article or placed directly adjacent to itself, the flaps 324 interlock with one another and/or opening portions 322, to create an interlocking structure. Interlocking can be measured as stated in the interlocking test articulated above.

When used herein with respect to single slit patterns and multi-slit patterns (defined below), the term “multibeam slits” is defined as one or more simple slits (in addition to the slits forming the single slit or multi-slit pattern) formed between two adjacent slits, where the two adjacent slits are either in the same row or adjacent rows. The beam region, and more specifically the direct path between the closest terminal ends of two adjacent slits in adjacent rows such as ends 316a and 314a of FIG. 3A, experience the highest concentration of forces when tension is applied to a single slit patterned material. As such, these beam regions experience the greatest stress concentration during deployment (or tension application or activation) of the material. This high stress concentration can result in tearing of the material during deployment. Additional slits added in this region that cross through the direct path between closest terminal ends in adjacent rows can create one or more additional force-carrying paths, or additional beams, which have additional stress concentrating terminal ends that can increase the maximum force bearing capacity of the material.

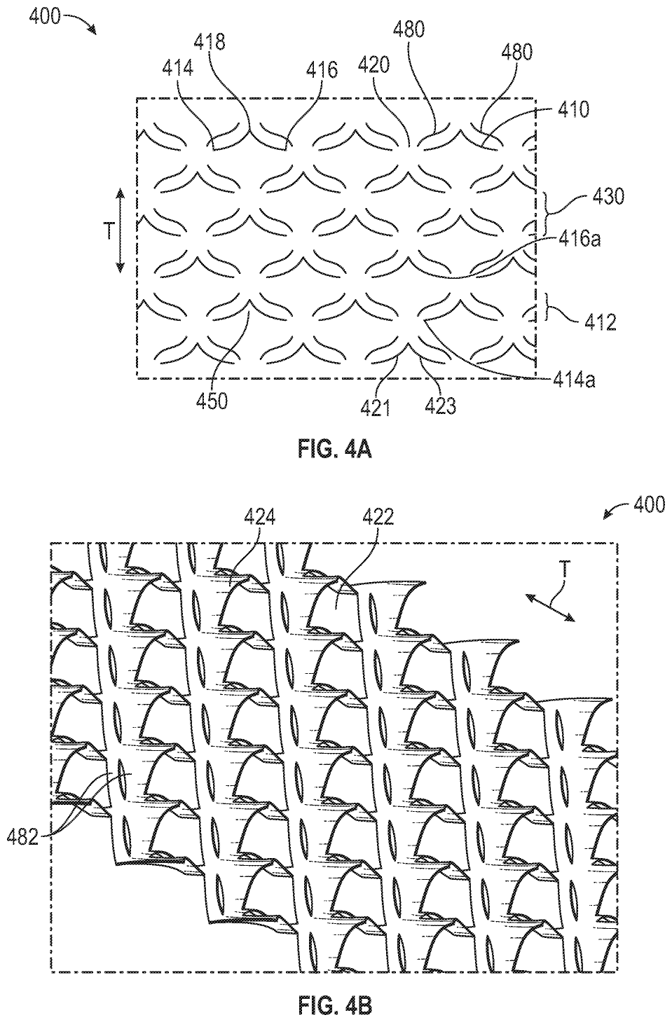

An exemplary single slit pattern including multibeam slits is shown in FIG. 4A-4D.

FIG. 4A is substantially identical to the embodiment shown in FIG. 3A except that the embodiment of FIG. 4A includes multibeams formed by multibeam slits. As such, the description of FIG. 3A is repeated herein. Multibeam slits 480 are formed between adjacent slits 410. Specifically, a first multibeam slit 480 is above and adjacent to curved first portion 421. A second multibeam slit 480 is above and adjacent to curved second portion 423. Whereas first and second portions 421, 423 connect at midpoint 418, first and second multibeam slits do not connect with one another.

Those of skill in the art will appreciate that many changes may be made to the pattern while still falling within the scope of the present disclosure. Those of skill in the art will appreciate that the shape and slit length can vary. The number of multibeam slits can vary. Alternatively, the row size or shape and beam size or shape can vary. Further, the degrees of offset or phase offset can vary from what is shown.

FIGS. 4B-4D show the pattern of FIG. 4A formed in a sheet of paper and exposed to tension along the tension axis T. When material 400 is tension activated or deployed along tension axis T, portions of material 400 experiences tension and/or compression that causes the material to move out of the original plane of material 400 in its pretensioned format. When exposed to tension along the tension axis, terminal ends 414, 416 experience compression and are drawn toward one another, causing a flap region 450 of the material 400 to move or buckle upward relative to the plane of the material 400 in its pretensioned state (FIG. 4A), creating flap 424. Portions of beams 430 move or buckle downward relative to the plane of the material 400 in its pretensioned state (FIG. 4A), forming an opening portion 422. The portion of the beam 430 containing the multibeam slit 480 between terminal ends 416a and 414a forms into two parallel beam sections 482 that have moved to align closer to the tension axis T. When tension is applied, both beam sections experience some tension in this embodiment. The axial beam 420 between adjacent slits 410 in a row 412 primarily experiences tension perpendicular to tension axis T. This region or area does not move substantially out of the original plane and instead bends slightly as compared to the pretensioned form of FIG. 4A. These movements in material 400 form a series of cusp, pointed protrusions, as seen in FIG. 4D.

In this exemplary embodiment, the slits 410 have two terminal ends. A straight, imaginary line extends between and connects these terminal ends. In this embodiment, the straight, imaginary line extending between and connecting the terminal ends of a first slit is substantially colinear with the straight, imaginary line extending between and connecting the terminal ends of a directly adjacent slit. In this exemplary embodiment, all of the straight, imaginary lines extending between and connecting the slit terminal ends in a row are approximately colinear.

When the tension-activated material 400 is wrapped around an article or placed directly adjacent to itself, the flaps 424 interlock with one another and/or opening portions 422, to create an interlocking structure. Interlocking can be measured as stated in the interlocking test articulated above.

Additional single slit patterns are shown in, for example, U.S. Patent Application No. 62/952,789, assigned to the present assignee, the entirety of which is incorporated herein.

### Multi-Slit Patterns

Various embodiments of the present disclosure relate to multi-slit patterns and to articles including these multi-slit patterns. The term “multi-slit pattern” includes double slit patterns, triple slit patterns, quadruple slit patterns, etc. Further, the term “multi-slit pattern” is meant to include any slit pattern wherein two or more slits that are each in different, directly adjacent rows substantially align with one another such that their terminal ends substantially align. Substantial alignment of the terminal ends of aligned multi-slits means that if you draw an imaginary line between two aligned terminal ends in two adjacent slits of the multi-slit, the angle of that imaginary line relative to the alignment axis (the axis that is perpendicular to the row(s)) is no greater than +/−20 degrees. In some embodiments, the length of each slit that forms a multi-slit differs by no more than +/−20% of the total length of the longest or shortest slit. In some embodiments, where the slits are linear, they are substantially parallel to one another. In some embodiments where the slits are not linear, the aligned multi-slits are all substantially aligned parallel to the tension axis within +/−20 degrees.

The midpoint of a section of transverse beam can be referred to as the geometric center of that section of the transverse beam. In some embodiments, the individual slits in a row are substantially aligned with the individual slits in more than one and less than a million directly adjacent, rows. In some embodiments, the slits are substantially perpendicular to the tension axis (T).

Double, triple, quadruple, or multi-slit patterns create significantly more out of plane undulation than single slit patterns when exposed to tension along a tension axis. This out of plane undulation of the material has great value for many applications. For example, these out of plane undulation areas create out of plane material or loops that can interlock with other areas of out of plane material or loops when portions of the material are placed adjacent to one another or wrapped together. As such, multi-slit patterns inherently interlock and/or include interlocking features. Once tension-activated, these features and patterns interlock and hold the material substantially in place.

The beam region, and more specifically the direct path between the closest terminal ends of two adjacent slits in adjacent rows experience the highest concentration of forces when tension is applied to a single slit patterned material. As such, these beam regions experience the greatest stress concentration during deployment (or tension application or activation) of the material. This high stress concentration can result in tearing of the material during deployment. Additional slits added in this region that cross through the direct path between closest terminal ends in adjacent rows can create one or more additional force-carrying paths, or additional beams, which have additional stress concentrating terminal ends that can increase the maximum force bearing capacity of the material.

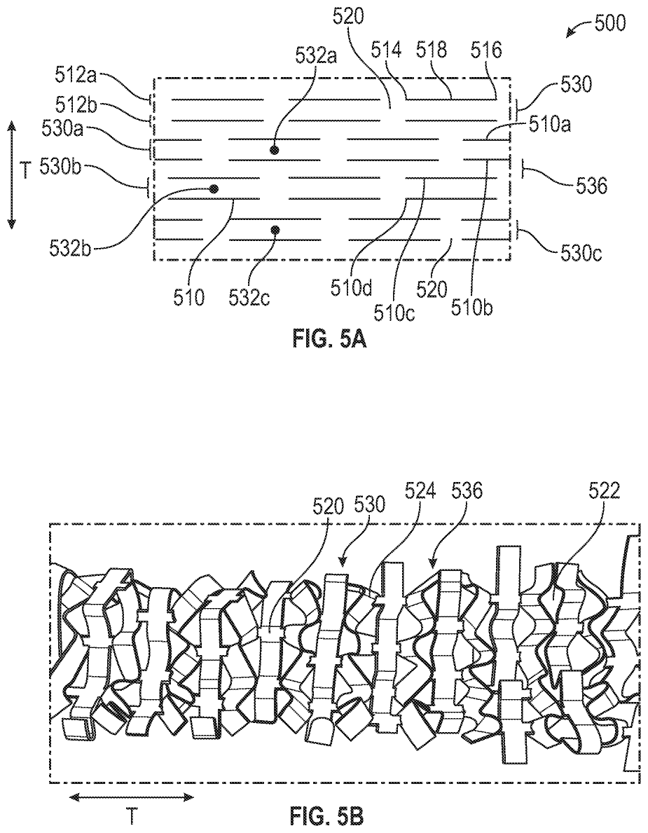

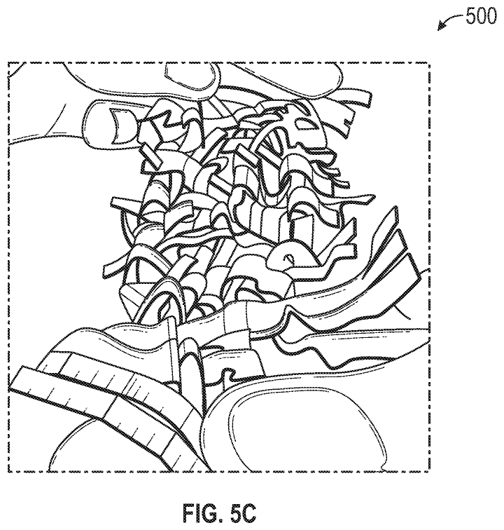

FIG. 5A is a schematic drawing of an exemplary double slit pattern. The pattern 500 includes a plurality of slits 510 in rows of slits 512. Each slit 510 includes a midpoint 518 between a first terminal end 514 and a second terminal end 516. A first row 512a of slits 510 and a second row 512b of slits 510 each include a plurality of slits 510 that are spaced from one another. The space between directly adjacent slits 510 in a row 512 in combination with the adjacent portion of the transverse beam 530 can be referred to as the axial beam 520. In the exemplary embodiment of FIG. 5A, a straight, imaginary line extends between and connects terminal ends 514, 516. In this exemplary embodiment, the straight, imaginary line extending between and connecting the terminal ends of a first slit is substantially colinear with the straight, imaginary line extending between and connecting the terminal ends of a directly adjacent second slit in the same row. In this exemplary embodiment, all of the straight, imaginary lines extending between and connecting the slit terminal ends in a single row are approximately colinear.

Together, rows 512a, 512b of slits 510 form a transverse beam 530. Transverse beam 530 is bound axially by slits 510. An overlap beam 536 is directly adjacent to and, in this embodiment, on both sides of each transverse beam 530. Overlap beam 536 is bound by non-aligned slits. The slits in each directly adjacent row 512a, 512b that forms an edge or side of transverse beam 530 are substantially aligned with one another such that they are substantially parallel and their terminal ends 514, 516 are substantially aligned perpendicular to the axis of the row and equidistant to one another. In some embodiments, the slits that are aligned have substantially the same slit length and pitch (pitch being relative to the tension axis).

More specifically, material 500 includes slits 510a, 510b, 510c, 510d. Together, slits 510a and 510b form a double slit. Also, together, slits 510c and 510d form another double slit. Slits 510a and 510b form sides or edges of a portion of a first transverse beam 530a. Slits 510b and 510c form sides or edges of a portion of overlap beam 536. Slits 510c and 510d form sides or edges of a portion of a second transverse beam 530b. Transverse beam 530a is directly adjacent to overlap beam 536. Overlap beam 536 is directly adjacent to transverse beam 530b. Slits 510a and 510b are substantially aligned with one another. Slits 510c and 510d substantially aligned with one another. Slits 510b and 510c are not aligned with one another. Instead, slits 510b and 510c are phase separated or spaced from one another. In the embodiment of FIG. 5A, slits 510 are substantially perpendicular to the tension axis T.

Each section of transverse beam 530 bordered by two parallel and substantially aligned slits 510 includes a midpoint 532 that is (1) at the midpoint (transversely) between first terminal end 514 and a second terminal end 516 of the slits 510 that form the sides of transverse beam 530 and (2) at the midpoint (axially) between the two slits 510 that form the sides of transverse beam 530. A midpoint 532a of a first section of transverse beam 530a is out of phase with a midpoint 532b of the directly adjacent section of the directly adjacent transverse beam 530b. In the embodiment of FIG. 5A, the midpoint 532a of a first section of transverse beam 530a substantially aligns axially with midpoint 532c of a first section of transverse beam 530c, which is the second directly adjacent transverse beam 530c from transverse beam 530a.

FIG. 5A also shows the tension axis (T) which is substantially parallel to the axial direction and substantially perpendicular to the transverse direction, and the direction of the rows of slits, in the embodiment of FIG. 5A. The tension axis (T) is an axis along which tension can be provided to deploy the material into which the pattern 500 has been formed, which creates the upward and downward movement of transverse beams 530 and rotation of overlap beams 536.

FIGS. 5B and 5C are drawings from photographs of a material including the slit pattern of FIG. 5A when exposed to tension along tension axis T. When material 500 is tension activated or deployed along tension axis T, portions of material 500 experience tension and/or compression that causes material 500 to move out of the original plane of material 500 in its non-tensioned format. When exposed to tension along the tension axis, terminal ends 514, 516 experience compression and are drawn toward one another, causing a flap region 550 of the material 500 to move or buckle upward relative to the transverse plane of the material 500 in its pretensioned state (FIG. 5A), creating a flap 524. Portions of transverse beams 530 undulate out of the original plane of the material 500 in its pretensioned state (FIG. 5A) forming loops, while staying nominally parallel to the tension axis. The axial beam 520 between adjacent slits 510 in a row 512 including adjacent portion of transverse beam 530 stays substantially parallel to the original plane of material 500 in its pretensioned state (FIG. 5A). Overlap beams 536 buckle and rotate out of the plane of the original material or sheet. The motion of the flap region 550 in combination with the undulation of the transverse beams 530 creates open portions 522.

Those of skill in the art will appreciate that many changes may be made to the pattern and material while still falling within the scope of the present disclosure. For example, in some embodiments, multi-slit pattern will be a triple slit, quadruple slit, or other multi-slit instead of a double slit pattern. Alternatively, the slit length, slit size, slit thickness, slit shape, row size or shape, transverse beam size or shape, and/or overlap beam size or shape can vary. Further, the degrees of offset or phase offset can vary from what is shown. The slit, row, or beam pitch can vary. The angle between the tension axis and slits can vary. Many of these changes could change the deployment pattern.

When the tension-activated material 500 is wrapped around an article or placed directly adjacent to itself, the transverse beams 530 and/or flaps 524 interlock with one another and/or opening portions 522, to create an interlocking structure. Interlocking can be measured as stated in the interlocking test articulated above.

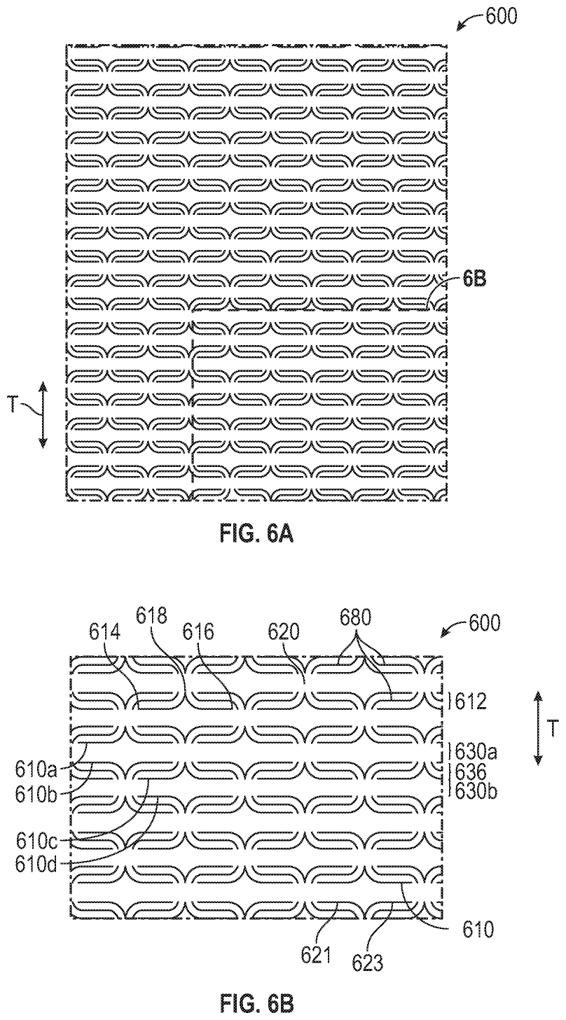

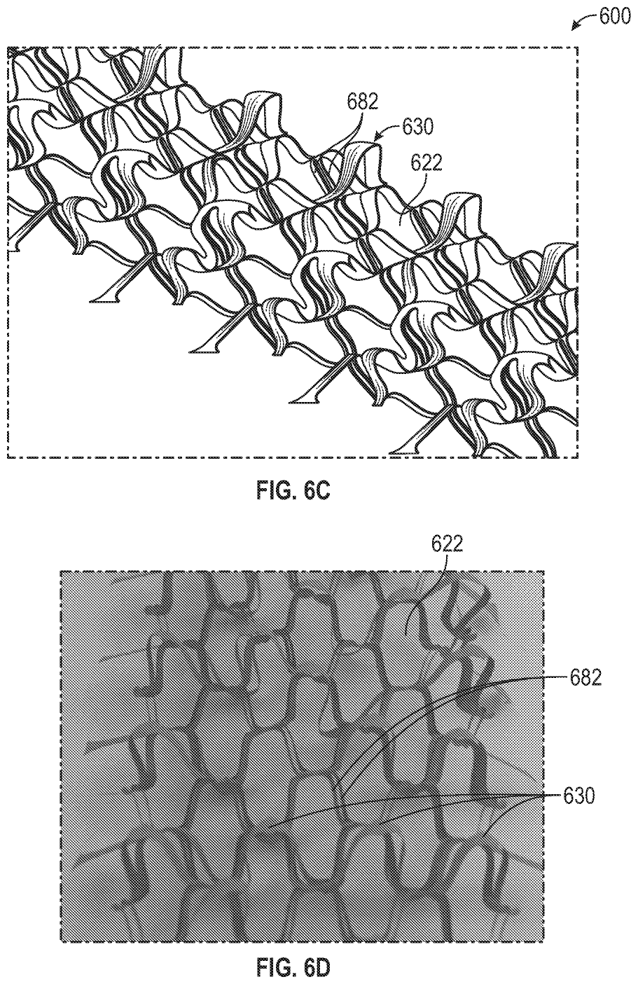

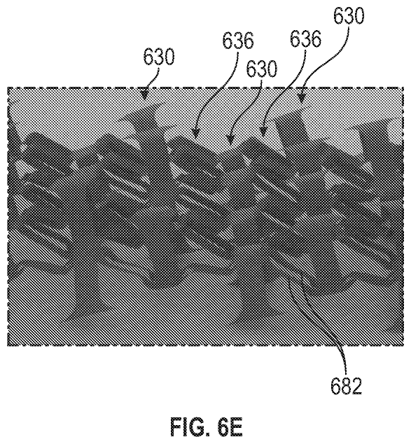

An exemplary embodiment of a slit pattern including multibeam slits is shown in FIGS. 6A-6E. The slit pattern of FIGS. 6A and 6B includes a first set of rows 612 that include slits 610 of a first shape and position and a second (inverted) shape and position. Slits 610 in a single row alternate in their shape/position such that the first shape or position slit is next to the second (inverted) shape or position slit, and this pattern repeats down the row. The slit shape is substantially the same except for the inversion.

The double-slit pattern formed in material 600 includes a plurality of slits 610 that each include a first terminal end 614, a second terminal end 616, and a midpoint 618. A plurality of individual slits 610 are aligned to form rows 612 that are generally perpendicular to tension axis T. An axial beam 620 is defined between adjacent slits 610 in a row 612 in combination with adjacent portions of transverse beam 630. In the exemplary embodiment of FIG. 6A, slits 610 are not straight lines (like slits 510 of the slit pattern of FIG. 5A) but instead are generally v-shaped or cusp-shaped. Slits 610 comprise a curved first portion 621 that is generally at a 45 degree angle to tension axis T and that connects with curved second portion 623 at a generally oblique angle. First and second portions 621, 623 connect at midpoint 618.

Material 600 includes slits 610a, 610b, 610c, 610d. Slits 610a and 610b form sides or edges of a portion of a first transverse beam 630a. Slits 610b and 610c form sides or edges of a portion of overlap beam 636. Slits 610c and 610d form sides or edges of a portion of a second transverse beam 630b. Transverse beam 630a is directly adjacent to overlap beam 636. Overlap beam 636 is directly adjacent to transverse beam 630b. Transverse beams 630a and 630b are directly adjacent transverse beams. Slits 610a and 610b are substantially aligned with one another. Slits 610c and 610d are substantially aligned with one another. Slits 610b and 610c are not aligned with one another. Instead, slits 610b and 610c are phase separated or spaced from one another. In the embodiment of FIG. 6A, slits 610 are substantially perpendicular to the tension axis T.

The continuous transverse region between the cusp-shaped slits 610 forms a transverse beam 630. This beam only occurs once between every two directly adjacent rows 612. Overlap beam 636 includes the area between adjacent slits 610 in a row 612. Axial beam 620 is present between adjacent slits 610 in a single row 612 in combination with the adjacent portions of the transverse beam 630.

In this exemplary embodiment, the slits have two terminal ends. A straight, imaginary line extends between and connects these terminal ends. In this embodiment, the straight, imaginary line extending between and connecting the terminal ends of a first slit is substantially colinear with the straight, imaginary line extending between and connecting the terminal ends of a directly adjacent slit. In this exemplary embodiment, all of the straight, imaginary lines extending between and connecting the slit terminal ends in a single row are approximately colinear.

Multibeam slits 680 (in this embodiment, one multibeam slit) are formed in overlap beam 636. These multibeam slits 680 will enable the formation of multibeams 682 when material 600 is exposed to tension along the tension axis. The multibeam slits 680, and the resulting multibeams, of FIG. 6A curve to follow or mimic the curvature of slits 610.

Those of skill in the art will appreciate that many changes may be made to the pattern while still falling within the scope of the present disclosure. in some embodiments, multi-slit pattern will be a triple slit, quadruple slit, or other multi-slit instead of a double slit pattern. Alternatively, the slit length, slit size, slit thickness, slit shape, row size or shape, transverse beam size or shape, and/or overlap beam size or shape can vary. Further, the degrees of offset or phase offset can vary from what is shown. The slit, row, or beam pitch can vary. The angle between the tension axis and slits can vary. The number, shape, size, etc. of the multibeam slits and/or multibeams can vary. Alternatively, the row size or shape and beam size or shape can vary. Further, the degrees of offset or phase offset can vary from what is shown. Many of these changes could change the deployment pattern.

FIG. 6C is a drawing rendered from a photograph and FIGS. 6D-6E are photographs of a material including the slit pattern of FIG. 6A when exposed to tension along tension axis T. The material deploys substantially as described with respect to the pattern of FIG. 5A, except that multibeams 682 form.

When the tension-activated material 600 is wrapped around an article or placed directly adjacent to itself, the flaps, loops, and undulations interlock with one another and/or opening portions 622, to create an interlocking structure. Interlocking can be measured as stated in the interlocking test articulated above.

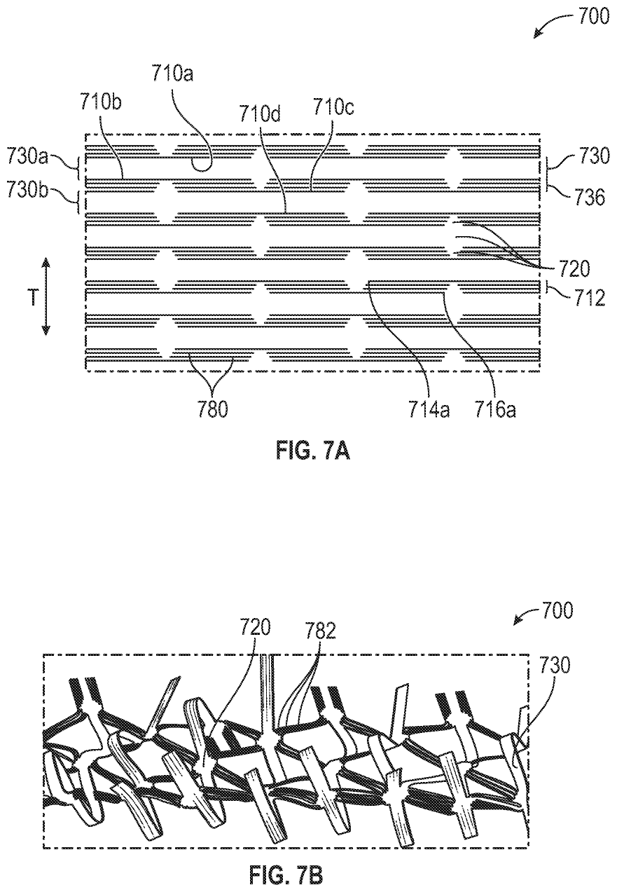

Another example of a double slit pattern is shown in FIG. 7A, which is a top view schematic drawing of a material including a double slit pattern similar to the one shown in FIG. 5A except that the slits include multibeam features. The beam region, and more specifically the direct path between the closest terminal ends of two adjacent slits in adjacent rows such as ends 716a and 714a of FIG. 7A, experience the highest concentration of forces when tension is applied to a single slit patterned material. As such, these beam regions experience the greatest stress concentration during deployment (or tension application or activation) of the material. This high stress concentration can result in tearing of the material during deployment. Additional slits added in this region that cross through the direct path between closest terminal ends in adjacent rows can create one or more additional force-carrying paths, or additional beams, which have additional stress concentrating terminal ends that can increase the maximum force bearing capacity of the material. Materials or articles that include multibeam slit patterns have a greater maximum tension force as compared to a material or article with the same pattern of beams but without multibeams. As used herein, the term “maximum tension force” refers to the maximum tensile force that can be applied to a sample of slit-patterned material before it tears. Generally, the maximum tension force occurs just before a slit-patterned material tears. A test method for measuring the maximum tension force is described in U.S. Patent Application No. 62/953,042, assigned to the present assignee, the entirety of which is incorporated by reference herein. The Maximum Tension Force (e.g., tear force), is the maximum force measured by the load frame as the sample is stretched. This is typically just before the material begins to tear. In some embodiments, materials or articles that include a multibeam slit pattern are capable of withstanding larger tension forces without tearing as compared to a material or article with the same pattern except without multibeams.

In some embodiments, materials or articles with multibeam slit patterns have the same or lower deployment force. As used herein, the term “deployment force” refers to the force required to substantially deploy the patterned sheet.

In some embodiments, it is advantageous to have the maximum tension force (the tension force required to tear the slit patterned material during deployment or tensioning along tension axis T) be greater than the deploy force (the force required to deploy the sample). The Max-Deploy

Ratio is the ratio of the maximum tension force divided by the deploy force. In some embodiments, it is advantageous for that ratio to be as large as possible such that the force applied to deploy a patterned sheet is much lower than the maximum force that the sheet can sustain. This prevents users of the sheet from accidentally tearing the material when deploying it.

Because FIG. 7A is substantially identical to the embodiment shown in FIG. 5A except that the embodiment of FIG. 7A includes multibeams, the description of FIG. 5A is repeated herein. Multibeam slits 780 (in this embodiment, two multibeam slits) are formed in overlap beam 736. These multibeam slits 780 will enable the formation of multibeams 782 when material 700 is exposed to tension along the tension axis. The multibeam slits 780, and the resulting multibeams 782, of FIGS. 7A and 7B are substantially linear.

Those of skill in the art will appreciate that many changes may be made to the pattern while still falling within the scope of the present disclosure. in some embodiments, multi-slit pattern will be a triple slit, quadruple slit, or other multi-slit instead of a double slit pattern. Alternatively, the slit length, slit size, slit thickness, slit shape, row size or shape, transverse beam size or shape, and/or overlap beam size or shape can vary. Further, the degrees of offset or phase offset can vary from what is shown. The slit, row, or beam pitch can vary. The angle between the tension axis and slits can vary. The number, shape, size, etc. of the multibeam slits and/or multibeams can vary. Alternatively, the row size or shape and beam size or shape can vary. Further, the degrees of offset or phase offset can vary from what is shown. Many of these changes could change the deployment pattern.

FIG. 7B is a drawing created from a photograph of a material including the slit pattern of FIG. 7A when exposed to tension along tension axis T. When material 700 is tension activated or deployed along tension axis T, portions of material 700 experience tension and/or compression that causes material 700 to move out of the original plane of material 700 in its non-tensioned format.

Portions of transverse beams 730 undulate out of the original plane of the material 700 in its pretensioned state (FIG. 7A) forming loops, while staying nominally parallel to the tension axis. The axial beam 720 between adjacent slits 710 in a row 712 and adjacent portion of transverse beam 730 stays substantially parallel to the original plane of material 700 in its pretensioned state (FIG. 7A). Overlap beams 736 buckle and rotate out of the plane of the original material or sheet. Because of the addition of two multibeam slits 780, each overlap beam 736 is cut into three distinct multibeams 782 that each carry tension and stay nominally parallel to each other and move or rotate as a group. The motion of the overlap beams 736 in combination with the undulation of the transverse beams 730 creates open portions 722. As such, the material 700 deploys substantially as described with respect to the pattern of FIG. 5A, except that multibeams 782 form.

When the tension-activated material 700 is wrapped around an article or placed directly adjacent to itself, the loops and undulations interlock with one another and/or opening portions 722, to create an interlocking structure. Interlocking can be measured as stated in the interlocking test articulated above.

Additional multi-slit patterns are shown in, for example, U.S. Patent Application No. 62/952,806, assigned to the present assignee, the entirety of which is incorporated herein.

### Compound Slit Patterns

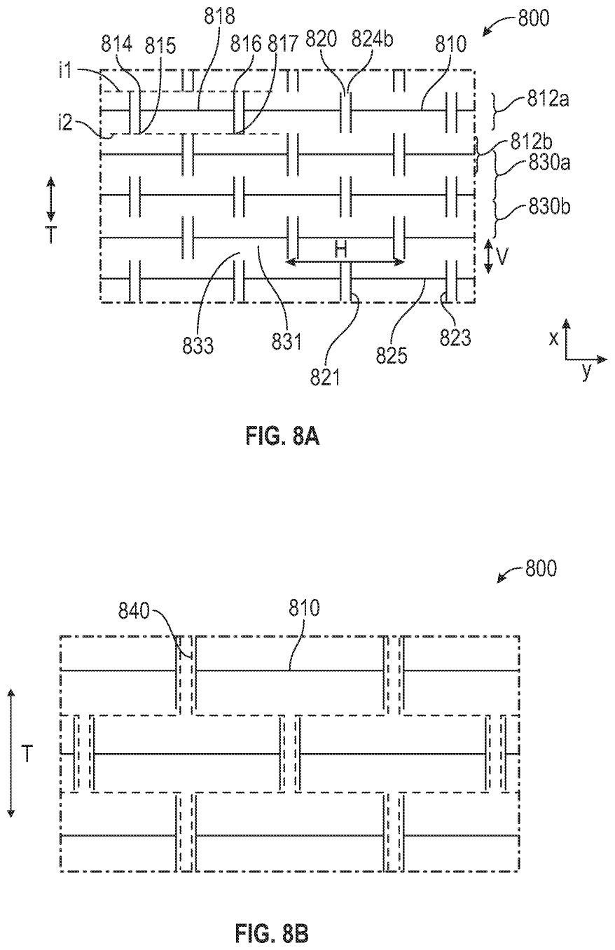

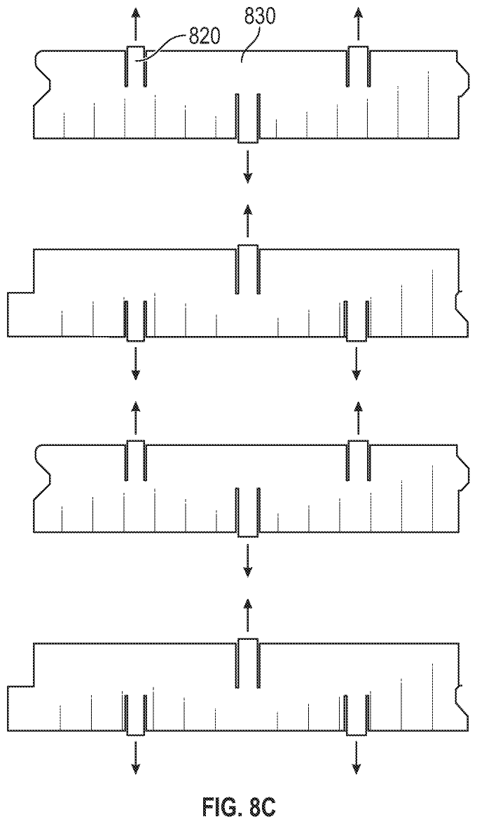

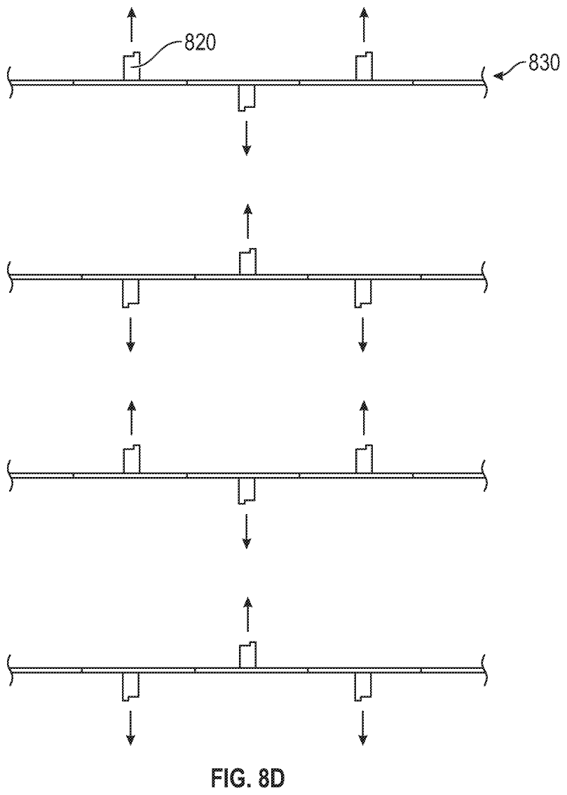

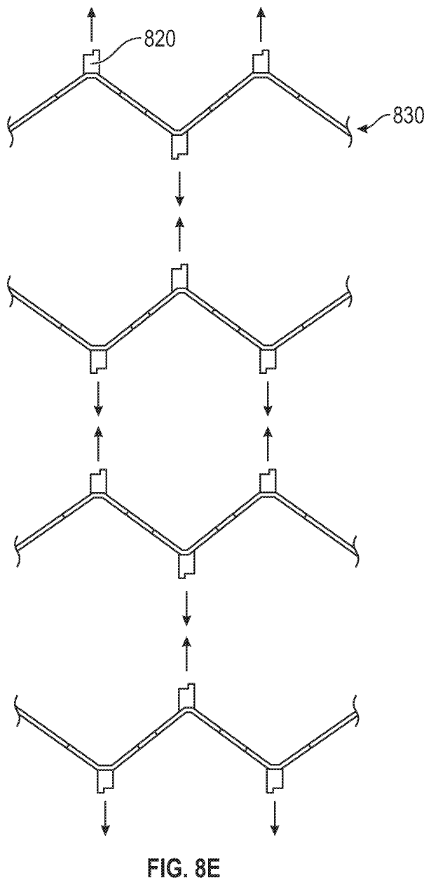

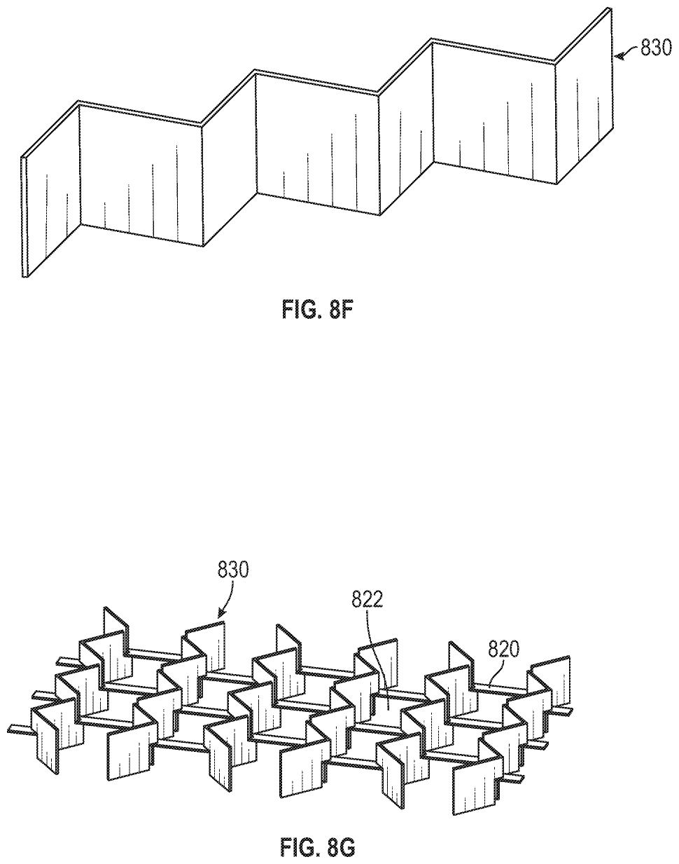

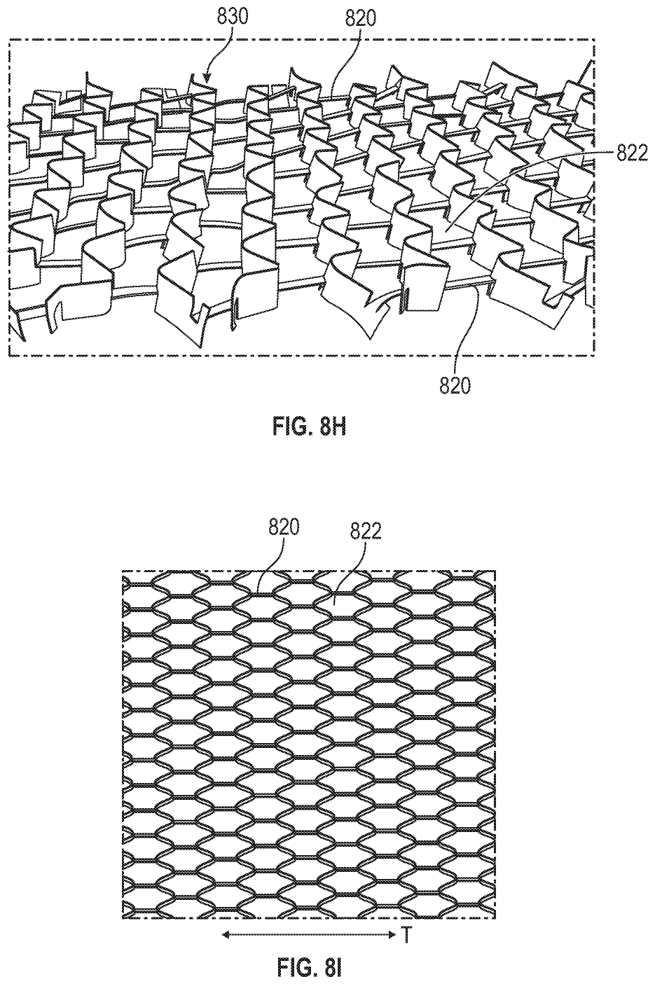

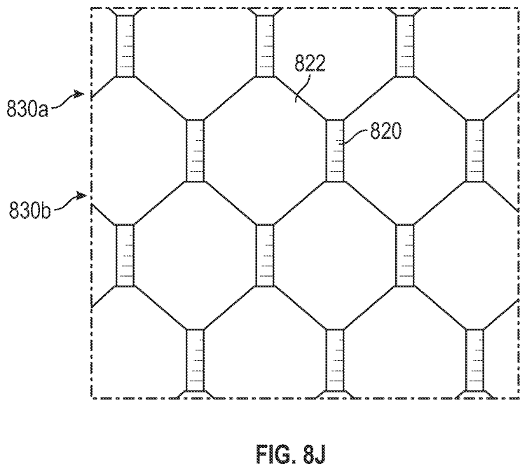

FIG. 8A is a top view schematic drawing of an exemplary compound slit pattern 800. A “compound slit” is defined herein as a slit that has more than two terminal ends, which is contrasted with a “simple slit,” which is defined herein as a slit with exactly two terminal ends. Compound slit patterns can be consistent with single-slit patterns or multi-slit patterns. In this example, the pattern 800 includes a plurality of slits 810 in rows of slits 812. Each slit 810 includes a first axial portion 821, a second axial portion 823 that is spaced from and generally parallel to first axial portion 821, and a generally transverse portion 825 that connects first and second axial portions 821, 823. Each slit 810 includes four terminal ends: a first terminal end 814, a second terminal end 815, a third terminal end 816, and a fourth terminal end 817. Each slit 810 has a midpoint 818.

The first terminal end 814 and the second terminal end 815 are opposite terminal ends of a first axial portion 821 of the slit 810. The third terminal end 816 and the fourth terminal end 817 are opposite terminal ends of second axial portion 823 of the slit 810. The first terminal end 814 is aligned with the second terminal end 816 along an axis in the axial direction x (which is parallel to the first axial portion 821 in the current example) and the third terminal end 816 is aligned with the fourth terminal 817 end along an axis in the axial direction (which is parallel to the second axial portion 823 in the current example). The first terminal end 814 is aligned with the third terminal end 816 along an axis i1 in the transverse direction y and the second terminal end 815 is aligned with the fourth terminal 817 end along an axis i2 in the traverse direction. The space between directly adjacent slits 810 in a row 812a, 812b can be referred to an axial beam 820. When exposed to tension, the axial beam 820 between adjacent slits 810 in a row 812a, 812b becomes a non-rotating beam 820 (visible in FIGS. 8C-8E and 8G). The space bounded by the generally transverse portions 825 subtracting the non-rotating beams 820 defines a folding wall regions 830a, 830b.

The folding wall regions 830a, 830b can be further described as having two generally rectangular regions 831 and 833, where rectangular region 831 is bound by (1) directly adjacent generally transverse portions 825 of slits 810 which are perpendicular to the tension axis and (2) adjacent axial portions 821 and 823 on directly adjacent, opposing slits 810. Axial beams 820 are between adjacent slits 810 in a single row 812a, 812b, more specifically, between the adjacent axial portions 821 and 823. Directly adjacent the beam 820 is a region 833 which is the remaining material in the folding wall region 830a, 830b bounded in the axial direction by the beam 820 and the generally transverse portion 825 and bounded in the transverse direction by the two generally rectangular regions 831, more specifically by the axial extensions of the adjacent axial portions 821 and 823. Directly adjacent rows of slits 810 are phase offset from one another.

In the embodiment of FIG. 8A, the tension axis T is substantially parallel to the axial direction x and substantially perpendicular to the transverse direction y. The tension axis T is generally perpendicular to the direction of the rows 812a, 812b of slits 810. The tension axis T is an axis along which tension can be provided to deploy the material into which the pattern 800 has been formed, which creates the rotation and upward and downward movement of portions of the material.

In the current example, unlike previous examples, there are no transverse beams extending across the width of the sheet of material in the transverse direction y. Rather, in the current example, there are folding wall regions 830a, 830b defined across the transverse width of the material 800 that alternate along the axial length of the sheet of material 800. Similar to some previous examples, in the current example the pattern of slits in the sheet of material defines a first row 812a and a second row 812b that alternate along the axial length of the sheet of material 800. The plurality of slits 810 in the sheet of material define columns of beams and rows of beams similar to that which has already been discussed. However, in the current example, each of the axial beams 820 extend from a first folding wall region 830a to an adjacent second folding wall region 830b. Furthermore, each of the axial beams 820 define two termini 824a, 824b corresponding to the terminal ends of adjacent slits in a row.

FIG. 8B shows the primary tension lines 840 (e.g., the lines approximating the highest tensile stress path) formed when an article including the slit pattern of FIG. 8A is deployed with tension along the tension axis T. FIG. 8B shows in dotted lines the primary tension lines 840, which are where the greatest tensile stress will occur. Tension lines are imaginary paths through the material that carry the greatest load when tension is applied to the material along the tension axis. When tension is applied along tension axis (T), the primary tension lines 840 move more closely into alignment with the applied tension axis, causing the sheet to distort. Tension lines 840 are focused in the axial beams 820 between adjacent slits in the same row. When exposed to tension, these beams 820 become non-rotating beams 820. In the embodiment of FIG. 8A, these beam 820 or non-rotating beams 820 are generally parallel to the tension axis. In the embodiment of FIG. 8A, these beams 820 or non-rotating beams 820 are generally axial. When tension is applied along the tension axis T (which in this embodiment is an axis nominally parallel to the non-rotating beams), then the tension (or the highest concentration of stress caused by that tension) exists on all the non-rotating beams 820 somewhat uniformly, but across sections of the folding wall region 830a, 830b as shown by the dotted lines.

FIGS. 8C-8G are top view schematic drawings showing how a material including the slit pattern of FIG. 8A moves in space when tension is applied along the tension axis T. When compound slit patterns are deployed, the activation of tension along the primary tension lines 840 causes substantially all regions of the pattern to experience some tension or compression (tensile stress or compressing stress) and some of the regions rotate and/or and bend out of the plane of the original two-dimensional film. The tension running through the folding wall region 830a, 830b causes the beams to rotate and fold at the same time to move the non-rotating beams 820 closer together to become more aligned with the tension axis T. In FIGS. 8C-8E, the non-rotating beams 820 are represented as being broken and connected with force vectors (arrows). This helps visualize the interaction of forces in different regions to clarify the motion of the material. Because the material 800 experiencing the forces is relatively thin, folding wall region 830a, 830b will rotate out of plane and fold at the base of the non-rotating beams 820 in response to the application of tension forces. Specifically, FIG. 8C shows non-rotating beams 820 with force vectors acting on the folding wall region 830a, 830b. This action causes the material 800 to move into the position shown schematically in FIG. 8D, in which the folding wall region 830a, 830b have rotated as a consequence of the force vectors shown in FIG. 8D. As shown in FIG. 8E, the folding wall regions 830a, 830b also fold or bend in response to the force vectors shown in FIG. 8C-8E. The degree of fold or bend will vary depending on many factors including, for example, the stiffness or modulus of the material, the magnitude of the tension forces, the dimensions and scale of the elements, the width of non-rotating beams, the span between non-rotating beams, etc.

FIG. 8D is a top view schematic drawing of folding wall region 830a, 830b showing only the rotation from a top view perspective in FIG. 8C. FIG. 8E is a schematic drawing showing a top view of the rotating beams that are both rotated and bent when fully tensioned and deployed. From a top view, folding wall region 830a, 830b, once rotated, form accordion folded vertical walls that can resist significant compressive force in the Z-axis (orthogonal to the x-y plane). The energy it takes to buckle the folded walls is the energy that can be absorbed by the structure to prevent damage to an object that it is wrapped around. Non-rotating beams 820 connect the folding wall regions 830a, 830b. The compound slit pattern of FIG. 8A results in the non-rotating beams 820 being staggered, which further contributes to the strength of the material when deployed. The motion of the non-rotating beams 820 and folding wall regions 830a, 830b produces open regions 822, which is visible in FIGS. 8G-8J.

Returning to FIG. 8A, the generally rectangular region 833 has a width, or transverse dimension, that is equal to the width, or transverse dimension, of the non-rotating beam 820. In some embodiments, it is preferred to have this width be small relative to the width, or transverse dimension, of the rectangular region 831. When the transverse width of the rectangular region 833 is small relative to the transverse width of the rectangular region 831, then the rectangular region 833 will substantially crease when deployed and not be clearly independently distinguishable from the remainder of the folding wall regions 830a, 830b as approximated by the drawing of FIG. 8F, and as is visible in FIG. 81. In particular, in the facing view (top or bottom) of the material of FIG. 8I the shape of the openings 822 appear to be generally hexagonal, as compared to the model view in FIG. 8J where it is more clearly visible in the facing view that the shape of the openings 822 are octagonal. If the rectangular region 833 is wide enough, then another flat vertical section will exist at the folds of the rotating/folding beam shown in FIG. 8J. Visually, this would make the hexagons look like octagons.

FIGS. 8H-8J are drawings from photographs of the compound slit pattern of FIG. 8A formed in a paper sheet and exposed to tension along the tension axis. FIG. 8H is a perspective side view, and FIG. 8I is a nearly top view, and FIG. 8J is a schematic drawing corresponding to FIG. 8I.

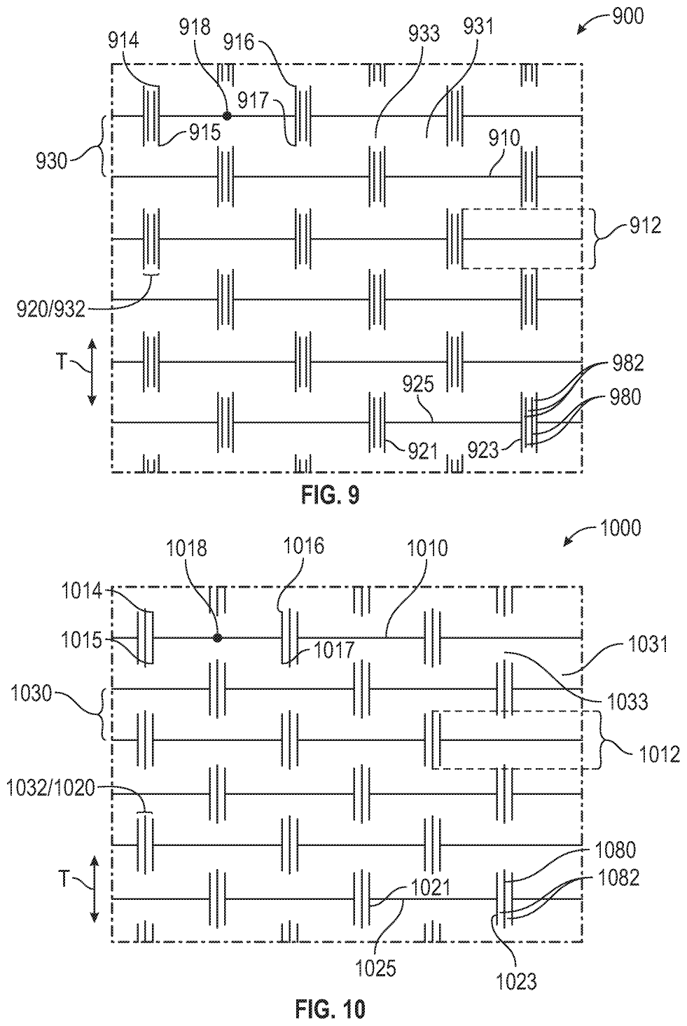

FIG. 9 is a top view schematic drawing of another exemplary compound slit pattern that is substantially the same as the compound slit pattern of FIG. 8A except that it shows an exemplary variation in which there are two multibeam slits 980 formed in the material (axial beam 920) between adjacent slits 910 in a row 912. The multibeam slits 980 create three multibeams 982 when the material into which the pattern is formed is tension-deployed.

More specifically, the pattern 900 includes a plurality of slits 910 in rows of slits 912. Each slit 910 includes a first axial portion 921, a second axial portion 923 that is spaced from and generally parallel to first axial portion 921, and a generally transverse portion 925 that connects first and second axial portions 921, 923. Each slit 910 includes four terminal ends 914, 915, 916, and 917 and a midpoint 918. First terminal ends 914, 915 are the terminal ends of first axial portion 921. Terminal ends 916, 917 are the terminal ends of second axial portion 923. The space between directly adjacent slits 910 in a row 912 can be referred to as the axial beam 920 between adjacent slits 910 in a row 912. When exposed to tension, the axial beam 920 between adjacent slits 910 in a row 912 becomes a non-rotating beam 932 that includes three multibeams 982. In this embodiment, two multibeam slits 980 are formed in the axial beam 920 between adjacent slits 910 in row 912. The multibeam slits 980 are slightly shorter in length than the generally axial slits 921, 923 of the directly adjacent slits 910 between which it is positioned. The midpoints of the multibeam slit 980 generally aligns with the midpoint of the generally axial slit portions 921, 923 and with the generally transverse slit portion 925. The multibeam slits 980 create three multibeams 982 when the material into which the pattern is formed is tension-deployed.

The space bounded by the generally transverse portions 925 subtracting the non-rotating beams 932 comprises a rotating/folding wall 930. The rotating/folding walls 930 can be further described as having two generally rectangular regions 931 and 933, where rectangular region 931 is bound by (1) directly adjacent generally transverse portions 925 of slits 910 which are perpendicular to the tension axis and (2) adjacent axial portions 921 and 923 on directly adjacent, opposing slits 910. The axial beam 920 is present between adjacent slits 910 in a single row 912, more specifically, between the adjacent axial portions 921 and 923. Directly adjacent the axial beam 920 is a region 933 which is the remaining material in the rotating/folding wall 930 bounded in the axial axis by the axial beam 920 and the generally transverse portion 925 and bounded in the transverse axis by the two generally rectangular regions 931, more specifically by the axial extensions of the adjacent axial portions 921 and 923. Directly adjacent rows of slits 910 are phase offset from one another.

In the embodiment of FIG. 9, the tension axis (T) is substantially parallel to the axial direction and substantially perpendicular to the transverse direction and to the direction of the rows 912 of slits 910. The tension axis (T) is an axis along which tension can be provided to deploy the material into which the pattern 900 has been formed, which creates the rotation and upward and downward movement of portions of the material.

The material deploys substantially as described above with respect to FIGS. 8A-81. The three multibeams 982 in the non-rotating beam 932 allows the material to experience larger tension forces without tearing. This is because the multibeams 982 create additional paths and corners to distribute the tension load reducing the peak stress that might initiate a tear.

FIG. 10 is a top view schematic drawing of another exemplary compound slit pattern that is substantially the same as the compound slit pattern of FIG. 9 except that it shows an exemplary variation in which there is one multibeam slit 1080 formed in the axial beam 1020 between adjacent slits 1010 in a row 1012 (the non-rotating beam). The multibeam slit 1080 creates two multibeams 1082 when the material into which the pattern is formed is tension-deployed.

More specifically, the pattern 1000 includes a plurality of slits 1010 in rows of slits 1012. Each slit 1010 includes a first axial portion 1021, a second axial portion 1023 that is spaced from and generally parallel to first axial portion 1021, and a generally transverse portion 1025 that connects first and second axial portions 1021, 1023. Each slit 1010 includes four terminal ends 1014, 1015, 1016, and 1017 and a midpoint 1018. First terminal ends 1014, 1015 are the terminal ends of first axial portion 1021. Terminal ends 1016, 1017 are the terminal ends of second axial portion 1023. The space between directly adjacent slits 1010 in a row 1012 can be referred to as the axial beam 1020 between adjacent slits 1010 in a row 1012. When exposed to tension, the material 1020 between adjacent slits 1010 in a row 1012 becomes a non-rotating beam 1032 that includes two multibeams 1082. In this embodiment, a multibeam slit 1080 is formed in the axial beam 1020 between adjacent slits 1010 in row 1012. The multibeam slit 1080 is slightly longer in length than the generally axial slits 1021, 1023 of the directly adjacent slits 1010 between which it is positioned. The midpoints of the multibeam slit 1080 generally aligns with the midpoint of the generally axial slit portions 1021, 1023 and with the generally transverse slit portion 1025. The multibeam slit 1080 creates two multibeams 1082 when the material into which the pattern is formed is tension-deployed.

The space bounded by the generally transverse portions 1025 subtracting the non-rotating beams 1032 comprises a rotating/folding wall 1030. The rotating/folding walls 1030 can be further described as having two generally rectangular regions 1031 and 1033, where rectangular region 1031 is bound by (1) directly adjacent generally transverse portions 1025 of slits 1010 which are perpendicular to the tension axis and (2) adjacent axial portions 1021 and 1023 on directly adjacent, opposing slits 1010. The axial beam 1020 is present between adjacent slits 1010 in a single row 1012, more specifically, between the adjacent axial portions 1021 and 1023. Directly adjacent the axial beam 1020 is a region 1033 which is the remaining material in the rotating/folding wall 1030 bounded in the axial axis by the axial beam 1020 and the generally transverse portion 1025 and bounded in the transverse axis by the two generally rectangular regions 1031, more specifically by the axial extensions of the adjacent axial portions 1021 and 1023. Directly adjacent rows of slits 1010 are phase offset from one another.

In the embodiment of FIG. 10, the tension axis (T) is substantially parallel to the axial direction and substantially perpendicular to the transverse direction and to the direction of the rows 1012 of slits 1010. The tension axis (T) is an axis along which tension can be provided to deploy the material into which the pattern 1000 has been formed, which creates the rotation and upward and downward movement of portions of the material.

The material deploys substantially as described above with respect to FIGS. 8A-8I. The two multibeams 1082 in the non-rotating beam 1032 allows the material to experience larger tension forces without tearing. This is because the multibeams 1082 create additional paths and corners to distribute the tension load reducing the peak stress that might initiate a tear.

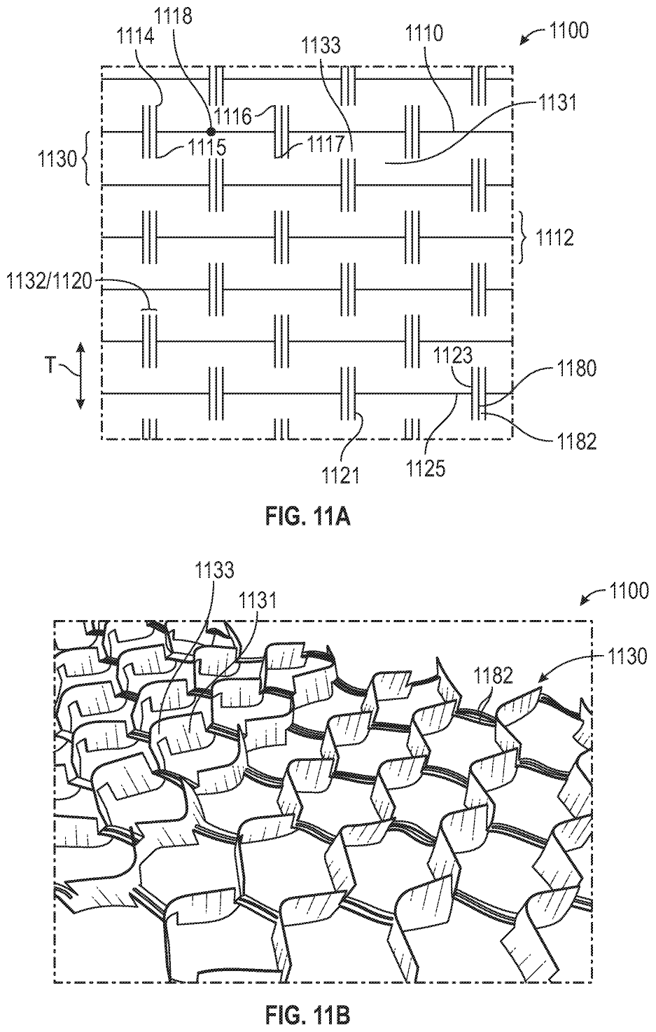

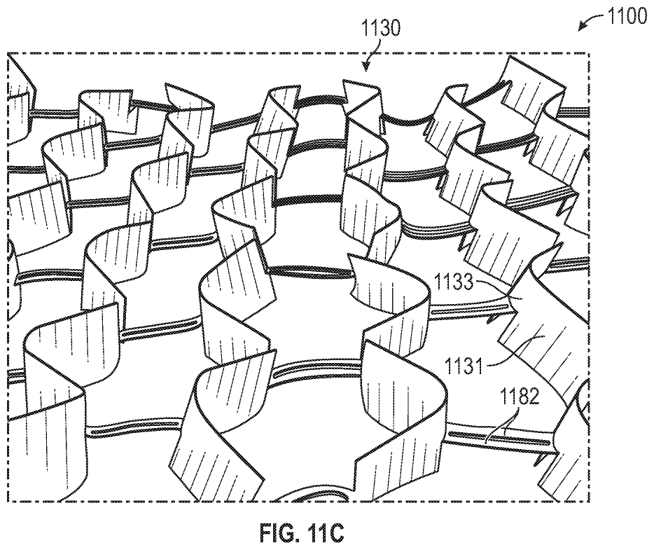

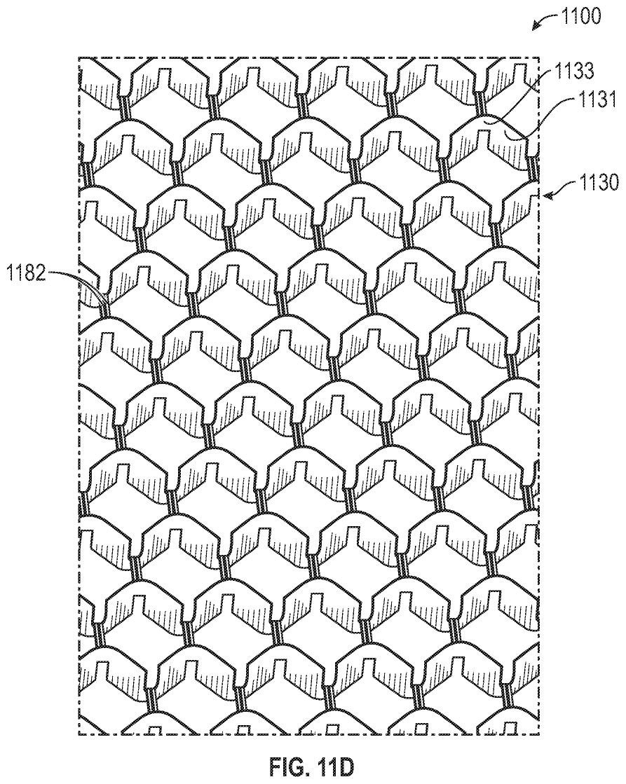

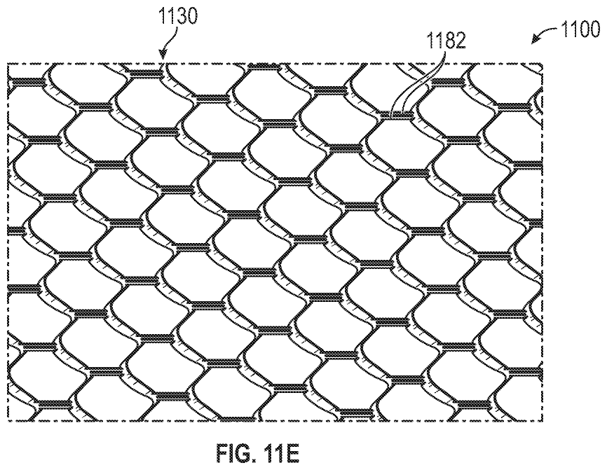

FIG. 11A is a top view schematic drawing of another exemplary compound slit pattern that is substantially the same as the compound slit pattern of FIG. 10 except that the multibeam slit 1180 is the same length as the generally axial slits 1121, 1123.

More specifically, the pattern 1100 includes a plurality of slits 1110 in rows of slits 1112. Each slit 1110 includes a first axial portion 1121, a second axial portion 1123 that is spaced from and generally parallel to first axial portion 1121, and a generally transverse portion 1125 that connects first and second axial portions 1121, 1123. Each slit 1110 includes four terminal ends 1114, 1115, 1116, and 1117 and a midpoint 1118. First terminal ends 1114, 1115 are the terminal ends of first axial portion 1121. Terminal ends 1116, 1117 are the terminal ends of second axial portion 1123. The space between directly adjacent slits 1110 in a row 1112 can be referred to as the axial beam 1120 between adjacent slits 1110 in a row 1112. When exposed to tension, the material 1120 between adjacent slits 1110 in a row 1112 becomes a non-rotating beam 1132 that includes two multibeams 1182. In this embodiment, a multibeam slit 1180 is formed in the axial beam 1120 between adjacent slits 1110 in row 1112. The multibeam slit 1180 approximately the same length as the generally axial slits 1121, 1123 of the directly adjacent slits 1110 between which it is positioned. Also, the midpoint of the multibeam slit 1180 generally aligns with the midpoint of the generally axial slit portions 1121, 1123 and with the generally transverse slit portion 1125. The multibeam slit 1180 creates two multibeams 1182 when the material into which the pattern is formed is tension-deployed.

The space bounded by the generally transverse portions 1125 subtracting the non-rotating beams 1132 comprises a rotating/folding wall 1130. The rotating/folding walls 1130 can be further described as having two generally rectangular regions 1131 and 1133, where rectangular region 1131 is bound by (1) directly adjacent generally transverse portions 1125 of slits 1110 which are perpendicular to the tension axis and (2) adjacent axial portions 1121 and 1123 on directly adjacent, opposing slits 1110. The axial beam 1120 is present between adjacent slits 1110 in a single row 1112, more specifically, between the adjacent axial portions 1121 and 1123. Directly adjacent the axial beam 1120 is a region 1133 which is the remaining material in the rotating/folding wall 11130 bounded in the axial axis by the axial beam 1120 and the generally transverse portion 1125 and bounded in the transverse axis by the two generally rectangular regions 1131, more specifically by the axial extensions of the adjacent axial portions 1121 and 1123. Directly adjacent rows of slits 1110 are phase offset from one another.

The tension axis (T) is substantially parallel to the axial direction and substantially perpendicular to the transverse direction and to the direction of the rows 1112 of slits 1110. The tension axis (T) is an axis along which tension can be provided to deploy the material into which the pattern 1100 has been formed, which creates the rotation and upward and downward movement of portions of the material.

FIGS. 11B-11E are drawings from photographs showing the compound slit pattern of FIG. 11A formed or cut into a material and then exposed to tension along tension axis T. The material deploys substantially as described above with respect to FIGS. 8A-8I. The two multibeams 1182 in the non-rotating beam 1132 allows the material to experience larger tension forces without tearing. This is because the multibeams 1182 create additional paths and corners to distribute the tension load reducing the peak stress that might initiate a tear.

Additional compound slit patterns are shown in, for example, U.S. Patent Application No. 62/952,815, assigned to the present assignee, the entirety of which is incorporated herein.

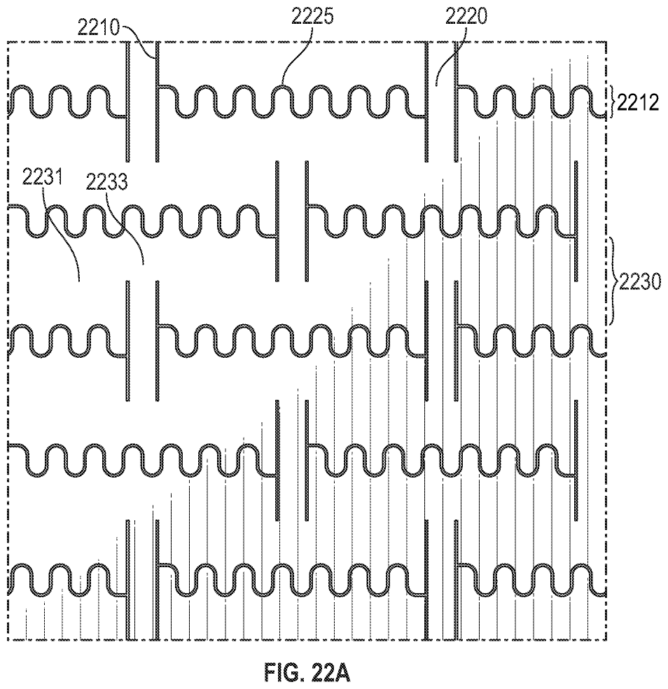

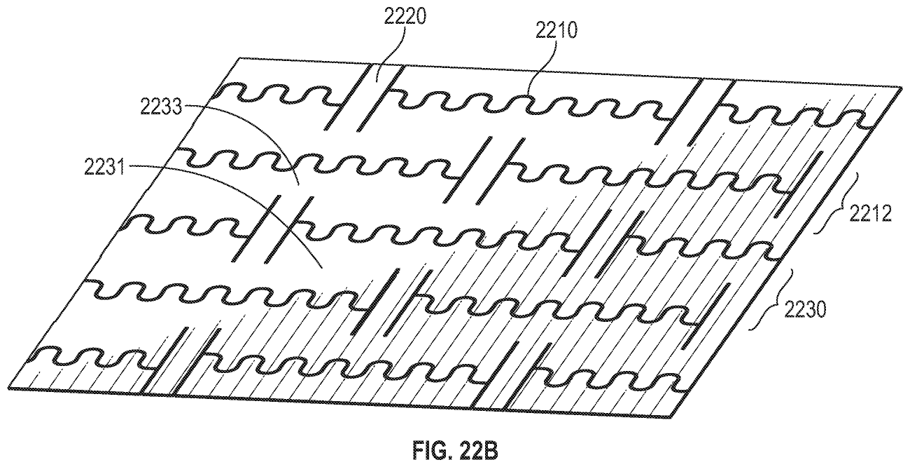

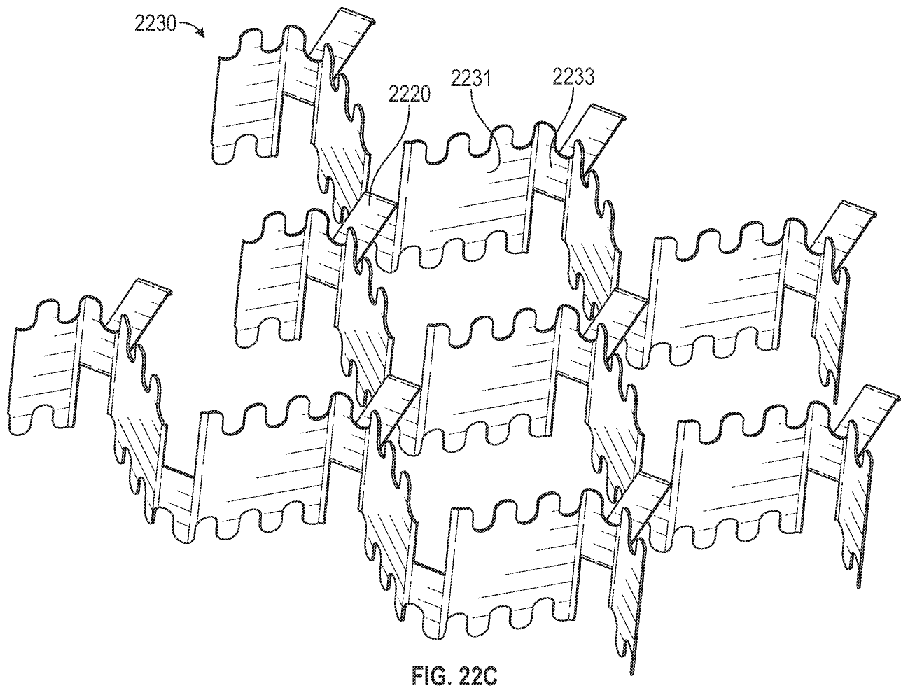

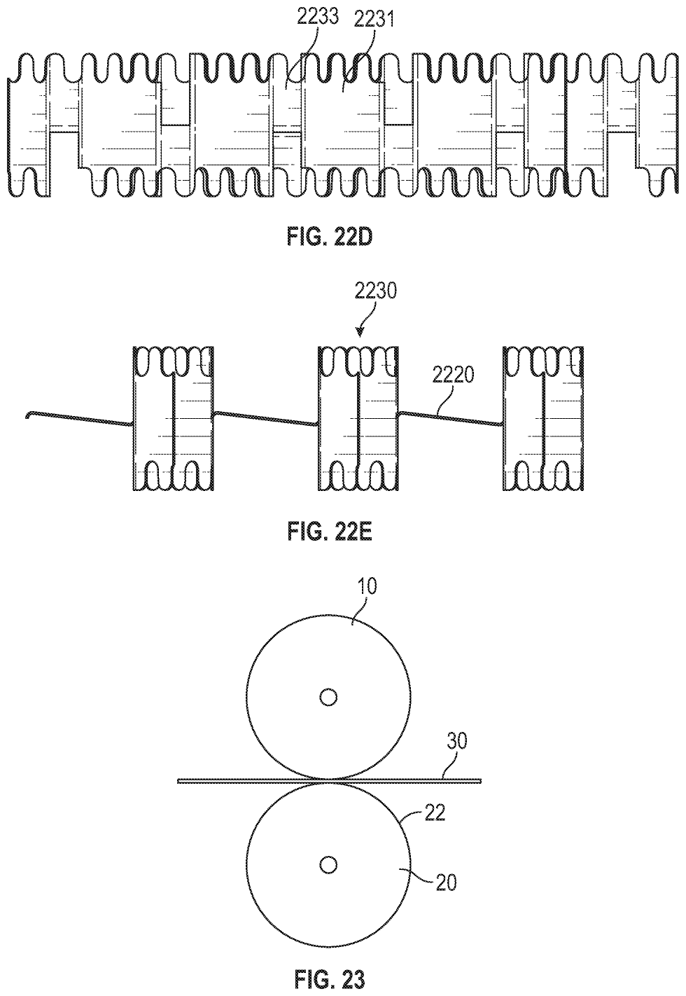

Yet another compound slit pattern in a sheet of material 2200 is depicted in FIGS. 22A-22B, which does not incorporate multibeam slits. The current example has interlocking features that defines a transverse portion 2225 of each of the slits. The transverse portion 2225 of each of the slits defines a curved line. In particular, the transverse portions 2225 of the slits in a row 2212 generally define an undulating wave or a sine wave that is interrupted by axial beams 2220 between each of the slits 2210. FIGS. 22C-22E show a sheet of material with the compound slit pattern of FIGS. 22A-22B when the material is expanded after being placed under tension in the tension axis. In some embodiments, multibeam slits can be incorporated in the pattern of FIGS. 22A-22E. For example, a multibeam slit can be disposed between adjacent slits in each row.

Any of the embodiments shown or described herein can be combined with other embodiments shown or described herein, including that any specific features, shapes, structures, or concepts shown or described herein can be combined with any of the other specific features, shapes, structures, or concepts shown or described herein. Those of skill in the art will appreciate that many changes may be made to the compound slit patterns, formation of the patterns into materials, and deployment of those materials while still falling within the scope of the present disclosure. For example, in embodiments showing a double slit pattern, the pattern could be a triple slit, quadruple slit, or other multi-slit pattern instead of a double slit pattern. Alternatively, the slit length, slit size, slit thickness, slit shape, row size or shape, transverse beam size or shape, and/or overlap beam size or shape can vary. Further, the degrees of offset or phase offset can vary from what is shown. The slit, row, or beam pitch can vary. The angle between the tension axis and slits can vary. The alignment of the pattern relative to the tension axis and/or sides of the material may vary. Some of these changes could change the deployment pattern.

Most of the slit patterns shown herein have regions that are described as moving or buckling either upward or downward relative to the original plane of the sheet when tension is applied. The distinction between upward and downward motion is an arbitrary description used for clarity to substantially match the accompanying figures. The samples could all be flipped over turning the downward motions into upward motions and vice versa. In addition, it is normal and expected for occasional inversions to occur where the regions of the sample will flip such that similar features which had moved upward in previous regions are now moving downward and vice versa. These inversions can occur for regions as small as a single slit, or large portions of the material. These inversions are random and natural, they are a result of natural variations in materials, manufacturing, and applied forces. Although some effort was made to photograph regions of material without inversions, all samples were tested with the presence of these natural variations and performance is not significantly affected by the number or location of inversions.

All of the slit patterns shown herein are shown as being generally perpendicular to the tension axis. While in many embodiments this can provide superior performance, any of the slit patterns shown or described herein can be rotated at an angle to the tension axis. Angles less than 45 degrees from the tension axis are preferred.

Further, all of the slit patterns shown herein include single slit that are out of phase with one another by approximately one half of the transverse spacing between directly adjacent slits (or 50% of the transverse spacing). However, the patterns may be out of phase by any desired amount including for example, one third of the transverse spacing, one quarter of the transverse spacing, one sixth of the transverse spacing, one eighth of the transverse spacing, etc. In some embodiments, the phase offset is less than 1 or less than three fourths, or less than one half of the transverse spacing of directly adjacent slits in a row. In some embodiments, the phase offset is more than one fiftieth, or more than one twentieth, or more than one tenth of the transverse spacing of directly adjacent slits in a row.

In some embodiments, the minimum phase offset is such that the terminal ends of slits in alternate rows intersect a line parallel to the tension axis through the terminal ends of slits in the adjacent rows. In some embodiments, the maximum phase offset is similarly limited by the creation of a continuous path of material. If the width of the slits orthogonal to the tension axis are constant for all slits and have a value w and the gap between slits orthogonal to the tension axis are constant and have a value g, then the minimum and maximum phase offsets are:

$$minimum phase offset = \frac{g}{w + g} , maximum phase offset = \frac{w}{w + g}$$

Articles. The present disclosure also relates to one or more articles or materials including any of the slit patterns described herein. Some exemplary materials into which the slit patterns described herein can be formed include, for example, paper (including cardboard, corrugated paper, coated or uncoated paper, kraft paper, cotton bond, recycled paper); plastic; woven and non-woven materials and/or fabrics; elastic materials (including rubber such as natural rubber, synthetic rubber, nitrile rubber, silicone rubber, urethane rubbers, chloroprene rubber, Ethylene Vinyl Acetate or EVA rubber); inelastic materials (including polyethylene and polycarbonate); polyesters; acrylics; and polysulfones. The article can be, for example, a material, sheet, film, or any similar construction.

Examples of thermoplastic materials that can be used include one or more of polyolefins (e.g., polyethylene (high density polyethylene (HDPE), medium density polyethylene (MDPE), low density polyethylene (LDPE), linear low density polyethylene (LLDPE)), metallocene polyethylene, and the like, and combinations thereof), polypropylene (e.g., atactic and syndiotactic polypropylene)), polyamides (e.g. nylon), polyurethane, polyacetal (such as Delrin), polyacrylates, and polyesters (such as polyethylene terephthalate (PET), polyethylene terephthalate glycol (PETG), and aliphatic polyesters such as polylactic acid), fluoroplastics (such as THV from 3M company, St. Paul, Minn.), and combinations thereof. Examples of thermoset materials can include one or more of polyurethanes, silicones, epoxies, melamine, phenol-formaldehyde resin, and combinations thereof. Examples of biodegradable polymers can include one or more of polylactic acid (PLA), polyglycolic acid (PGA), poly(caprolactone), copolymers of lactide and glycolide, poly(ethylene succinate), polyhydroxybutyrate, and combinations thereof.

“Paper” as used herein refers to woven or non-woven sheet-shaped products or fabrics (which may be folded, and may be of various thicknesses) made from cellulose (particularly fibers of cellulose, (whether naturally or artificially derived)) or otherwise derivable from the pulp of plant sources such as wood, corn, grass, rice, and the like. Paper includes products made from both traditional and non-traditional paper making processes, as well as materials of the type described above that have other types of fibers embedded in the sheet, for example, reinforcement fibers. Paper may have coatings on the sheet or on the fibers themselves. Examples of non-traditional products that are “paper” within the context of this disclosure include the material available under the trade designation TRINGA from PAPTIC (Espoo, Finland), and sheet forms of the material available under the trade designation SULAPAC from SULAPAC (Helsinki, Finland)

The material in which the single slit pattern is formed can be of any desired thickness. In some embodiments, the material has a thickness between about 0.001 inch (0.025 mm) and about 5 inches (127 mm). In some embodiments, the material has a thickness between about 0.01 inch (0.25 mm) and about 2 inches (51 mm). In some embodiments, the material has a thickness between about 0.1 inch (2.5 mm) and about 1 inch (25.4 mm). In some embodiments, the thickness is greater than 0.001 inch (0.025 mm), or 0.01 inch (0.25 mm), or 0.05 inch (1.3 mm), or 0.1 inch (2.5 mm), or 0.5 inch (13 mm), or 1 inch (25 mm), or 1.5 inches (38 mm), or 2 inches (51 mm), or 2.5 inches (64 mm), or 3 inches (76 mm). In some embodiments, the thickness is less than 5 inches (127 mm) or 4 inches (101 mm), or 3 inches (76 mm), or 2 inches (51 mm), or 1 inch (25 mm), or 0.5 inch (13 mm), or 0.25 inch (6.3 mm), or 0.1 inch (2.5 mm).

In some embodiments, where the material is paper, the thickness is between about 0.003 inch (0.076 mm) and about 0.010 inch (0.25 mm). In some embodiments where the material is plastic, the thickness is between about 0.005 inch (0.13 mm) and about 0.125 inch (3.2 mm).

In some embodiments, the slit or cut pattern extends substantially to one or more of the edges of the sheet, film, or material. In some embodiments, this allows the material to be of unlimited length and also to be deployed by tension, particularly when made with non-extensible materials. A “non-extensible” material is generally defined as a material that when in a cohesive, unadulterated configuration (absent slits) has an ultimate elongation value of under 25%, less than or equal to 10% or, in some embodiments, less than or equal to 5%. The amount of edge material is the area of material surrounding and not including the single slit pattern. In some embodiments, the amount of edge material, or down-web border, can be defined as the width of the rectangle whose long axis is parallel to the tension axis and is infinitely long and can be drawn on the substrate without overlapping or touching any slits. In some embodiments, the amount of edge material is less than 0.010 inch (0.25 mm) or less than 0.001 inch (0.025 mm). In some embodiments, the width of the down-web border is less than 0.010 inch (0.25 mm) or less than 0.001 inch (0.025 mm). In some embodiments, the amount of edge material is less than 5 times the thickness of the substrate. In some embodiments, the width of the down-web border is less than 5 times the thickness of the substrate.

Cross-web slabs can be defined as rectangular regions with a rectangle whose long axis is perpendicular to the tension axis and is infinitely long and whose width is some finite number and can be drawn on the substrate without overlapping or touching any slits or cuts. In some embodiments, cross-web slabs of any width may already exist within the article as an integral part of the pattern. In some embodiments, cross-web slabs of any width may be added to the ends of a finite length article to make the article easier to deploy. In some embodiments, cross-web slabs of any width may be added intermittently to a continuously patterned article.

In some embodiments, the distance between the farthest spaced terminal ends of a single slit (also referred to as the slit length) is between about 0.25 inch (0.001 mm) long and about 3 inches (76 mm) long, or between about 0.5 inch (13 mm) and about 2 inches (51 mm), or between about 1 inch (25 mm) and about 1.5 inches (38 mm). In some embodiments, the farthest distance between terminal ends of a single slit (also referred to as slit length) is between 50 times the substrate thickness and 1000 times the substrate thickness, or between 100 and 500 times the substrate thickness. In some embodiments, the slit length is less than 1000 times the substrate thickness, or less than 900 times, or less than 800 times, or less than 700 times, or less than 600 times, or less than 500 times, or less than 400 times, or less than 300 times, or less than 200 times, or less than 100 times the substrate thickness. In some embodiments, the slit length is greater than 50 times the substrate thickness, or greater than 100 times, or greater than 200 times, or greater than 300 times, or greater than 400 times, or greater than 500 times, or greater than 600 times, or greater than 700 times, or greater than 800 times, or greater than 900 times the substrate thickness.

Methods of Making. The slit patterns and articles described herein can be made in a number of different ways. For example, the slit patterns can be formed by extrusion, molding, laser cutting, water jetting, machining, stereolithography or other 3D printing techniques, laser ablation, photolithography, chemical etching, rotary die cutting, stamping, other suitable negative or positive processing techniques, or combinations thereof. In particular, with reference to FIG. 23, paper or another sheet material 30 can be fed into a nip consisting of a rotary die 20 and an anvil 10. In this example the material 30 is stored in a roll configuration where the material is rolled around a central axis that may include or may omit a central core. The rotary die 20 has cutting surfaces 22 on it that correspond to the pattern desired to be cut into the sheet material 30. The die 20 cuts through the material 30 in desired places and forms the slit pattern described herein. The same process can be used with a flat die and flat anvil.

Methods of Using. The articles and materials described herein can be used in various ways. In one embodiment, the two dimensional sheet, material, or article has tension applied along the tension axis, which causes the slits to form the openings and/or flaps and/or motions described herein. In some embodiments, the tension is applied by hand or with a machine.

Uses. The present disclosure describes articles that begin as a flat sheet but deploy into a three-dimensional construction upon the application of force/tension. In some embodiments, such constructions form energy absorbing structures. The patterns, articles, and constructions described herein have a large number of potential uses, at least some of which are described herein.

One exemplary use is to protect objects for shipping or storage. As stated above, existing shipping materials have a variety of drawbacks including, for example, they occupy too much space when stored before use (e.g., bubble wrap, packing peanuts) and thus increase the cost of shipping; they require special equipment to manufacture (e.g., inflatable air bags); they are not always effective (e.g., crumpled paper); and/or they are not widely recyclable (e.g., bubble wrap, packing peanuts, inflatable air bags). The tension-activated, expanding films, sheets, and articles described herein can be used to protect items during shipping without any of the above drawbacks.

When made of sustainable materials, the articles described herein are effective and sustainable. Because the articles described herein are flat when manufactured, shipped, sold, and stored and only become three-dimensional when activated with tension/force by the user, these articles are more effective and efficient at making the best use of storage space and minimizing shipping/transit/packaging costs. Retailers and users can use relatively little space to house a product that will expand to 10 or 20 or 30 or 40 or more times its original size. Further, the articles described herein are simple and highly intuitive for use. The user merely pulls the product off the roll or takes flat sheets of product, applies tension across the article along the tension axis (which can be done by hand or with a machine), and then wraps the product around an item to be shipped. In many embodiments, no tape is needed because the interlocking features enable the product to interlock with another layer of itself.

In some embodiments, the slit patterns described herein create packaging materials and/or cushioning films that provide advantages over the existing offerings. For example, in some embodiments, the packaging materials and/or cushioning films of the present disclosure provide enhanced cushioning or product protection. In some embodiments, the packaging materials and/or cushioning films of the present disclosure provide similar or enhanced cushioning or product protection when compared to the existing offerings but are recyclable and/or more sustainable or environmentally friendly than existing offerings. In some embodiments, the packaging materials and/or cushioning films of the present disclosure provide similar or enhanced cushioning or product protection when compared to the existing offerings but can be expanded and wrapped around an item to be shipped. Constructions that hold their shape once tension is applied can be preferred because they may eliminate the need for tape to hold the material in place for many applications.

The following examples describe some exemplary constructions and methods of constructing various embodiments within the scope of the present application. The following examples are intended to be illustrative, but are not intended to limit the scope of the present application.

### EXAMPLES

Tear Test:

For this test, rectangular test specimens including repeating slit patterns and clamping regions that lacked slit patterns at either end were used. The width and length of the test specimens varied depending on the Example based on the respective slit patterns and their corresponding deployment distances. It is important to note that many unique samples can be created, but care should be used when directly comparing two samples. For example, if the widths of the samples are not the same, then the tear forces should be normalized by dividing by the width.

To carry out the test, the test specimens were clamped in the clamping regions along each edge of their short axis, one edge to a fixed clamp and one edge to a moving clamp of a mechanical load frame [MTS Criterion Model C43 104E, from Mechanical Testing Systems Corporation, Eden Prairie, Minn.]. The samples were then stretched along their long axis at a rate of 1 mm/s until the sample was torn in two while recording the force, distance and time. The data was analyzed to determine the Deployment Force, Maximum Tension Force, and Ratio of Maximum Tension Force to Deployment Force. The Maximum Tension Force, or tear force, is the maximum force measured by the load frame as the sample is stretched. This is typically just before the material begins to tear. Deployment Force is the maximum force recorded on the load frame from the start of stretching up to an extension that is halfway to the point at which it experiences the Maximum Tension Force. The Max-Deploy Ratio is the ratio of the maximum tension force divided by the deployment force.

### Examples 1-10

Example 1-10 samples were prepared by laser cutting a slit pattern on a substrate. The substrate was a white paper obtained from Boise Paper, Lake Forest, Ill., US. The paper is made from 100% virgin fibers with a basis weight of about 82 g/m² when measured according to test method TAPPI T410 om-13, a thickness of about 0.0048 inch (0.12 mm) when measured according to test method TAPPI T411 om-10, a tear strength when measured according to test method T414 om-12 of about 50 g/ply in the machine direction and about 60 g/ply in the cross direction. The laser cutting method involved using a Model XLS 10.150D laser cutter (obtained from Universal Laser Systems, Inc., Scottsdale, Ariz., US) cutting at 80-100% power with the z height set to 0. A default setting of “continuous cast acrylic” was used.

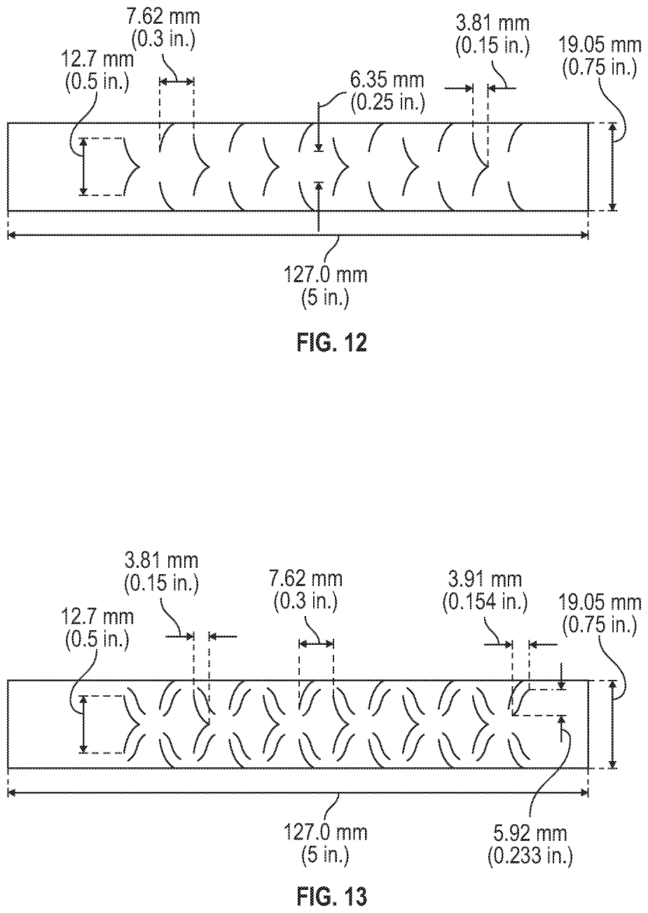

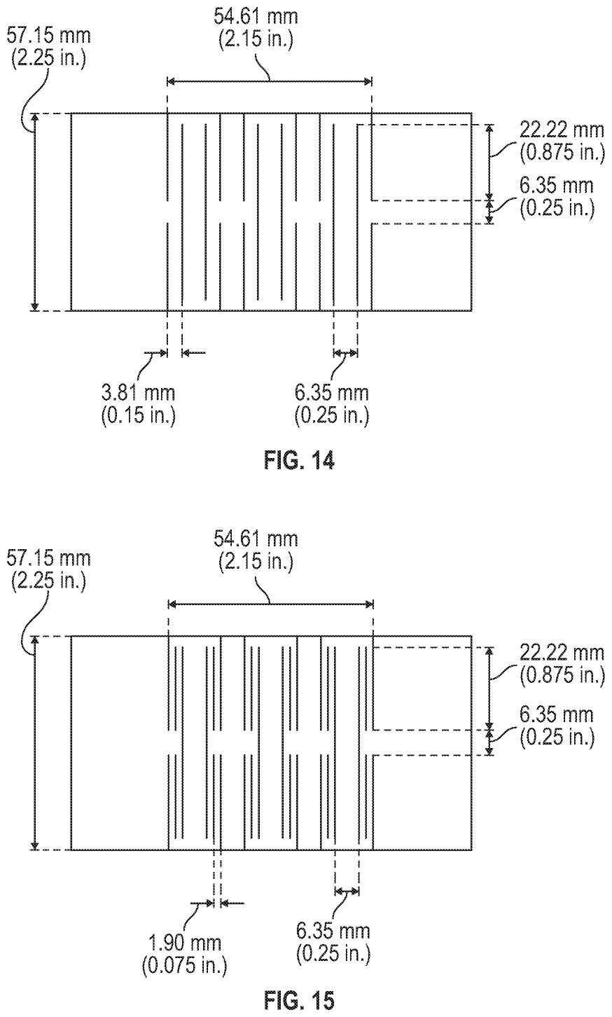

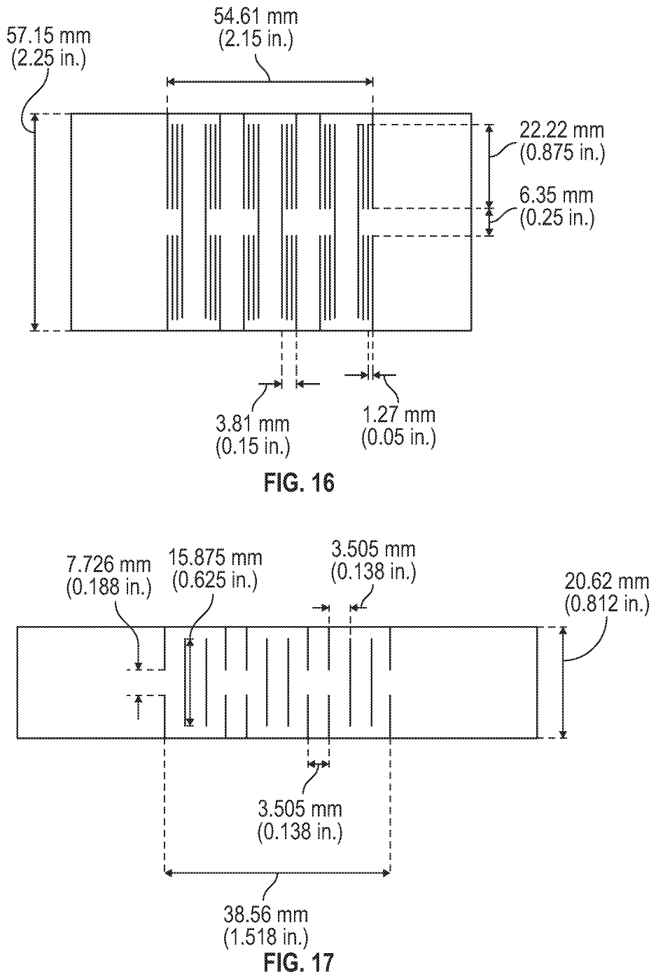

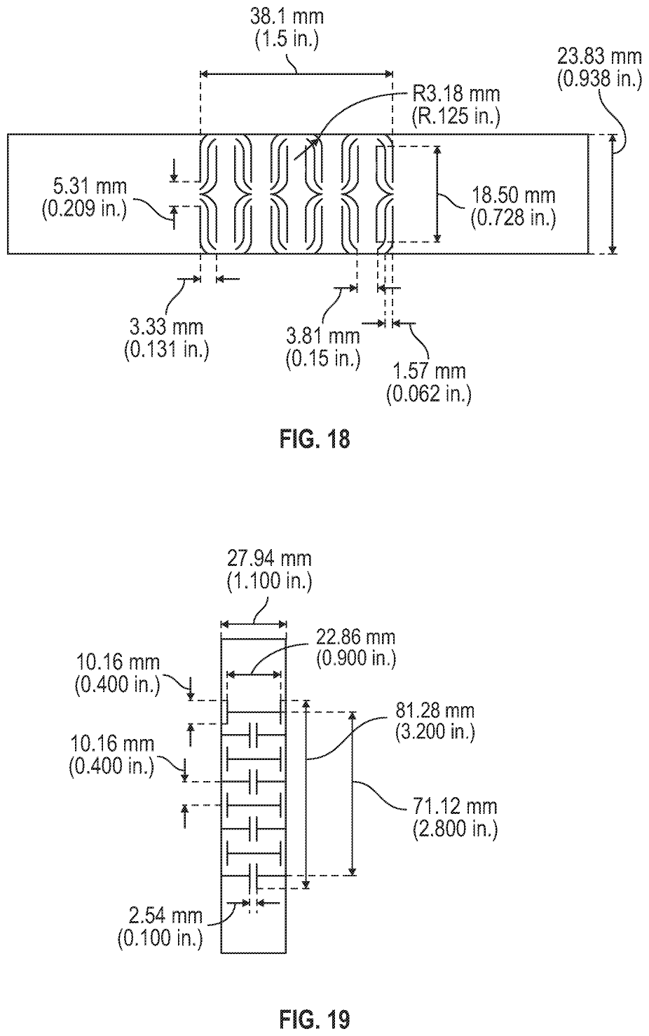

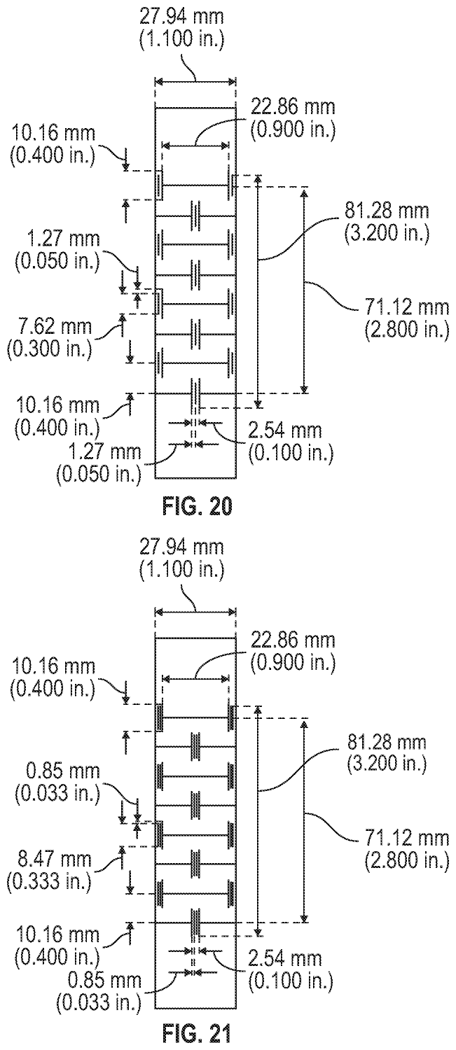

The slit patterns shown in FIGS. 12-21 were used to form Examples 1-10, respectively.

Each sample was tested according to the Tear Test provided above. Deployment Force, Maximum Tension Force, and Ratio of Maximum Tension Force to Deployment Force for each of Examples 1-10 are summarized in Table 1, below.

As described in the Tear Test above, if the Tear Test Results for two samples with different sample widths are to be compared, care should be taken to normalize the tear forces by dividing the measured force by the width. For example, to compare Tear Test Results for Examples 6 and 7 (which have different widths), the data must be normalized by dividing each by the width as shown in Table 2, below.

TABLE 1
Tear Test Results.

| | | Maximum | Max Tension | |
|---|---|---|---|---|
| | Deployment | Tension | Force/Deployment | |
| | Force (N) | Force (N) | Force | FIG. |
| Example 1 | 10.36 | 11.34 | 1.1 | 12 |
| Example 2 | 9.48 | 16.07 | 1.7 | 13 |
| Example 3 | 0.29 | 1.81 | 6.7 | 14 |
| Example 4 | 0.29 | 3.60 | 13.0 | 15 |
| Example 5 | 0.26 | 4.73 | 20.0 | 16 |
| Example 6 | 0.75 | 1.77 | 2.31 | 17 |
| Example 7 | 0.42 | 2.61 | 6.23 | 18 |
| Example 8 | 0.29 | 1.45 | 5.0 | 19 |
| Example 9 | 0.32 | 1.61 | 5.0 | 20 |
| Example 10 | 0.33 | 1.74 | 5.3 | 21 |

TABLE 2
Normalized Tear Test Results for Examples 6 and 7

| | Deployment | Maximum | Max Tension | |
|---|---|---|---|---|
| | Force per | Tension Force | Force/Deployment | |
| | width (N/m) | per width (N/m) | Force | FIG. |
| Example 6 | 36.4 | 85.8 | 2.31 | 17 |
| Example 7 | 17.6 | 109.5 | 6.23 | 18 |

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described embodiments (or one or more aspects thereof) may be used in combination with each other. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention can be determined with reference to the appended claims, along with the full scope of equivalents to which such claims are entitled.

The recitation of all numerical ranges by endpoint is meant to include all numbers subsumed within the range (i.e., the range 1 to 10 includes, for example, 1, 1.5, 3.33, and 10).

The terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

Those having skill in the art will appreciate that many changes may be made to the details of the above-described embodiments and implementations without departing from the underlying principles thereof. Further, various modifications and alterations of the present disclosure will become apparent to those skilled in the art without departing from the spirit and scope of the disclosure. The scope of the present application should, therefore, be determined only by the following claims and equivalents thereof.

1. An expanding material having a tension axis, comprising:
a sheet of material having a plurality of slits defining a slit pattern that include one or more multibeam slits, wherein the sheet of material defines a plane in a pre-tensioned form and is three-dimensional when tension is applied to the tension axis.

2. The expanding material of claim 1, wherein at least portions of the material rotate 45 degrees or greater from the plane when tension is applied along the tension axis.

3. The expanding material of claim 1, wherein the slits define at least one of a single slit pattern, multi-slit pattern, and compound slits.

4. (canceled)

5. The expanding material of claim 1, wherein the plurality of slits defines a pattern that extends through one or more of the edges of the material.

6. (canceled)

7. The expanding material of claim 1, wherein the material is paper having a thickness of about 0.003 inch (0.076 mm) to about 0.010 inch (0.25 mm).

8. The expanding material of claim 1, wherein the material is plastic having a thickness of about 0.005 inch (0.13 mm) to about 0.125 inch (3.2 mm).

9. (canceled)

10. The expanding material of claim 1, wherein each of the slits define a slit length that is perpendicular to the tension axis.

11. The expanding material of claim 1, wherein the plurality of slits are arranged in rows and the slits in a first row of slits are offset from an adjacent row of slits by 75% or less of the transverse length of a slit in the first row of slits.

12. The expanding material of claim 1, wherein the plurality of slits are arranged in rows and each of the slits have a slit shape and slit orientation and wherein the slit shape or orientation varies within a row of slits.

13. The expanding material of claim 1, wherein the plurality of slits are arranged in rows and each of the slits have a slit shape and slit orientation and wherein the slit shape or orientation varies in adjacent rows.

14. (canceled)

15. The expanding material of claim 1, wherein the each slit in the plurality of slits has a slit length that is about 0.25 inch (6.35 mm) to about 3 inches (76.2 mm).

16. (canceled)

17. A die capable of forming the plurality of slits of claim 1.

18. A packaging material comprising the expanding material of claim 1.

19. The packaging material of claim 18, wherein the expanding material is stored in a roll configuration.

20. The packaging material of claim 18, wherein the expanding material is one or more individual sheets.

21. The packaging material of claim 20, further comprising an envelope having the expanding material disposed in the envelope.

22. A method of making the expanding material of claim 1, comprising:
forming the plurality of slits in the material by at least one of by extrusion, molding, laser cutting, water jetting, machining, stereolithography, laser ablation, photolithography, chemical etching, rotary die cutting, stamping, or combinations thereof.

23. A method of using the expanding material of claim 1, comprising:
applying tension to the expanding material along a tension axis to cause the material to expand.

24. The method of claim 23, wherein the application of tension causes one or more of (1) the slits to form openings and/or (2) the material adjacent to the slits to move out of plane.

25. (canceled)

26. The method of claim 23, wherein applying tension to the expanding material along the tension axis causes the material to change from a two-dimensional structure to a three-dimensional structure.
